(19) United States
(12) Patent Application Publication
(10) Pub. No.: US 2025/0251651 A1
(43) Pub. Date: Aug. 7, 2025

(54) SKI POLE WITH CAMERA MOUNT

(71) Applicant: GoPro, Inc., San Mateo, CA (US)

(72) Inventors: Nicholas D. Woodman, Big Sky, MT (US); David Thomas Platner, San Francisco, CA (US); Ian Copeland Griggs, San Francisco, CA (US); Huy Phuong Nguyen, Alpine, UT (US); Joseph Tucker, Santa Cruz, CA (US)

(21) Appl. No.: 19/039,858

(22) Filed: Jan. 29, 2025

Related U.S. Application Data
(60) Provisional application No. 63/548,997, filed on Feb. 2, 2024.
(60) Provisional application No. 63/557,652, filed on Feb. 26, 2024.

(51) Int. Cl. G03B 17/56; A63C 11/22

(52) U.S. Cl. CPC G03B 17/561; A63C 11/221; A63C 11/227; A63C 11/228

(57) ABSTRACT

A ski pole assembly that includes: a ski pole, which defines a cavity; an extension, which is at least partially received by the cavity and is configured to traverse the cavity along a longitudinal axis of the ski pole; and a mounting mechanism that is configured to removably couple an attachment to the extension.

### CROSS-REFERENCE TO RELATED APPLICATION(S)

This application claims the benefit of and priority to U.S. Provisional Patent Application Ser. No. 63/548,997, filed on Feb. 2, 2024, and U.S. Provisional Patent Application Ser. No. 63/557,652, filed on Feb. 26, 2024, the entire contents of each of the above-identified applications being hereby incorporated by reference.

### TECHNICAL FIELD

This disclosure relates to ski poles and ski pole mounts for attaching a camera as well as to optical modules and accessories for use therewith (e.g., ski poles, handheld grips, tripods, selfie sticks, mounts, etc.).

### BACKGROUND

Image capture apparatuses are used in a variety of applications, including, for example, handheld cameras and video recorders, cell phones, drones, etc., and typically include an optical module with one or more lenses (or other such optical elements) and one or more image sensors. The lens(es) capture content by receiving and focusing light, and the image sensor(s) convert the captured content into an electronic image signal that is processed by an image signal processor to generate an image. In some optical modules, the lens(es) and the image sensor(s) are integrated into a single unit, which is known as an integrated sensor-lens assembly (ISLA).

Often times, an image capture apparatus will be used with an accessory (e.g., a handheld grip, a tripod, a selfie stick, a mount, a ski pole, etc.). When connected, however, the assembly of the image capture apparatus and the accessory can be top-heavy, which can result in instability and influence the user experience.

Ease of use and convenience of mounting or carrying an image capture apparatus is important to users that record both day-to-day and high-intensity activities. By way of example, users may require mounting or carrying imaging devices during high-intensity activities such as skiing, snowboarding, and biking. Smaller devices with simpler interfaces may attract a wider number of users. However, providing extensive processing, storage, and/or capability to smaller imaging devices may be difficult with tight packaging constraints and limited interface options. An image capture apparatus that is easy to mount in a variety of ways, that is small and unobtrusive, and that includes an easy-to-use interface may beneficially improve a user's experience with the imaging device, especially during high-intensity activities.

The image capture apparatuses, the optical modules, and the accessories for use therewith described herein address these concerns, among others, by redistributing the overall weight of the system via the relocation of various components from the optical module to the accessory, which results in a small, unobtrusive image capture apparatuses with robust mounting capabilities.

### SUMMARY

In one aspect of the present disclosure, a ski pole assembly is disclosed that includes: a ski pole, which defines a cavity; an extension that is at least partially received by the cavity; and a mounting mechanism that is coupled to the extension. The extension is configured to traverse the cavity along a longitudinal axis of the ski pole. Additionally, the mounting mechanism is configured to removably couple an attachment to the extension.

In certain embodiments, the ski pole assembly may further include a grip that surrounds a portion of the ski pole and that defines a cavity. The extension may be configured to be at least partially located within the cavity of the grip.

In certain embodiments, the extension may be configured to move with respect to the ski pole along the longitudinal axis of the ski pole such that the extension moves into and out of the ski pole.

In certain embodiments, the ski pole assembly may further include a grip that defines a cavity therein that is coaxial with the cavity of the ski pole and extends along the longitudinal axis of the ski pole. The extension may be configured to be received by the cavity of the grip and the cavity of the ski pole.

In certain embodiments, the extension may include a first segment and a second segment. The first segment may be pivotally coupled to a grip that surrounds the cavity of the ski pole. The first segment may be configured to move with respect to the grip along the longitudinal axis of the ski pole. Additionally, the first segment may define a cavity therein. The second segment may be pivotally coupled to the first segment and configured to be at least partially received by the cavity of the first segment. The second segment may be configured to move with respect to the first segment along a longitudinal axis of the first segment.

In certain embodiments, the ski pole assembly may further include a support arm pivotally coupled to the extension and configured to be at least partially received by the cavity of the ski pole. The support arm may be configured to couple to the ski pole. The extension may include a first end and a second end that opposes the first end. The mounting mechanism may be coupled to the first end and the support arm may be pivotally coupled to the extension between the first end and the second end.

In certain embodiments, the mounting mechanism may include a pair of fingers that are configured to interlock with another pair of fingers associated with the attachment. The attachment may be configured to pivot with respect to the mounting mechanism. The mounting mechanism may be rotatably coupled to the extension.

In certain embodiments, the mounting mechanism may include a ball portion that is configured to be removably coupled to the attachment and a socket portion that may be coupled to the extension and receive the ball portion therein.

In certain embodiments, the extension may include an indicator line that may indicate a position of the extension with respect to the ski pole such that the attachment counterbalances the ski pole.

In certain embodiments, the attachment may be a camera.

In another aspect of the present disclosure, a ski pole assembly is disclosed that includes: a ski pole; an extension that is connected to the ski pole; and a mounting mechanism that is connected to the extension and which is configured for removable connection to an image capture apparatus such that the image capture apparatus is connectable to the ski pole via the extension.

In certain embodiments, the extension may be rotatably connected to the ski pole to facilitate repositioning of the image capture apparatus.

In certain embodiments, the extension may be telescopically reconfigurable between collapsed and expanded configurations.

In another aspect of the present disclosure, a ski pole assembly is disclosed that includes a mounting mechanism, which is configured for engagement with an image capture apparatus such that the image capture apparatus is directly connectable to the ski pole assembly.

In certain embodiments, the mounting mechanism may include first fingers that are configured for engagement with second fingers on the image capture apparatus.

In certain embodiments, the mounting mechanism may include a threaded fastener that is configured for engagement with the image capture apparatus.

In another aspect of the present disclosure, an image capture system is disclosed that includes an optical module and an accessory.

The optical module includes an integrated sensor-lens assembly (ISLA), which includes an image sensor and a lens that receives and directs light onto the image sensor.

The accessory is configured for electrical communication with the optical module and includes a system on chip (SoC) and at least one first heat sink that directs heat away from the SoC.

In certain embodiments, the image capture system may further include a tether that connects the ISLA and the SoC to facilitate data and/or power communication therebetween.

In certain embodiments, the optical module and the accessory may be configured for releasable connection.

In certain embodiments, the optical module may further include an inertial measurement unit.

In certain embodiments, the optical module may further include at least one microphone.

In certain embodiments, the optical module may further include at least one second heat sink that distributes heat away from the ISLA.

In certain embodiments, the accessory may further include a power source.

In certain embodiments, the accessory may further include a display.

In certain embodiments, the accessory may further include at least one operational button to control operation of the optical module and/or the accessory.

In another aspect of the present disclosure, an image capture system is disclosed that includes an optical module and an accessory.

The optical module includes: an ISLA, wherein the ISLA includes an image sensor and a lens that receives and directs light onto the image sensor; a first heat sink that distributes heat away from the ISLA; an inertial measurement unit; at least one microphone; a SoC; a second heat sink that distributes heat away from the SoC; and at least one operational button to control operation of the image capture system.

The accessory is configured for releasable connection to the optical module and includes a power source and a display.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture apparatus.

FIGS. 2A-2B are isometric views of another example of an image capture apparatus.

FIG. 3 is a top view of another example of an image capture apparatus.

FIGS. 4A-4B are isometric views of another example of an image capture apparatus.

FIG. 5 is a block diagram of electronic components of an image capture apparatus.

FIG. 6A is a perspective view of a ski pole assembly in a collapsed position.

FIG. 6B is a perspective view of the ski pole assembly of FIG. 6A in an extended position.

FIG. 7A is a perspective view of an example of a mounting mechanism of a ski pole assembly.

FIG. 7B is a perspective view of another example of a mounting mechanism of a ski pole assembly.

FIG. 7C is a perspective view of another example of a mounting mechanism of a ski pole assembly.

FIG. 8 is a perspective view of another example of a ski pole assembly.

FIG. 9A is a perspective view of another example of a ski pole assembly that includes a support arm in a collapsed position.

FIG. 9B is a perspective view of the ski pole assembly of FIG. 9A with the support arm in an extended position.

FIG. 10 is a perspective view of another example of a ski pole assembly.

FIG. 11A is a perspective view of another example of a ski pole assembly.

FIG. 11B is a perspective view of another example of a ski pole assembly.

FIG. 12 is a schematic view of an example of image capture system according to the principles of the present disclosure that includes an optical module and a (first) accessory.

FIG. 13 is a schematic view illustrating use of the optical module seen in FIG. 12 with another example of an image capture apparatus, which is configured to removably receive the optical module.

FIG. 14 is a schematic view of another embodiment of the optical module seen in FIG. 12, which includes a pair of ISLAs.

FIG. 15 is a front, perspective view of one embodiment of the accessory seen in FIG. 12, which is configured as a handheld apparatus.

FIG. 16 is a front, perspective view of another embodiment of the accessory seen in FIG. 12, which is configured as a selfie stick.

FIG. 17 is a front, perspective view of another embodiment of the accessory seen in FIG. 12, which is configured as the ski pole seen in FIG. 6A.

FIG. 18 is a front, perspective view of another embodiment of the accessory seen in FIGS. 12, which is configured as the ski pole seen in FIG. 6B.

FIG. 19 is a schematic view of another embodiment of the accessory seen in FIG. 12, which is configured for connection to a (second) accessory.

FIG. 20 is a schematic view of another embodiment of the image capture system seen in FIG. 12, which includes an alternate distribution of components.

FIG. 21 is a schematic view of another embodiment of the image capture system, which includes a pair of the optical modules seen in FIG. 12.

FIG. 22 is a schematic view of another embodiment of the image capture system, which includes a pair of the optical modules seen in FIG. 12 and an interposer.

### DETAILED DESCRIPTION

In one aspect, the present disclosure describes an image capture apparatus (e.g., a camera) and mounting mechanisms of the image capture apparatus to couple to the image capture apparatus to one or more objects. By way of example, the present implementations describe an image capture apparatus that may be mounted to, or integrated into, a ski pole (i.e., a ski pole assembly that may include the image capture apparatus, the mounting mechanism, and the ski pole). The image capture apparatus described herein may be small in size, lightweight, and easily portable such that the image capture apparatus may facilitate mounting to the ski pole using a mounting mechanism. As a result, the image capture apparatus may enable seamless capture of high-quality images in situations that would otherwise require a more complicated process for image capturing or discourage image capturing altogether. By way of example, the present implementations may facilitate capturing high-quality images by a skier via mounting the image capture apparatus to the ski pole.

In another aspect, the present disclosure describes an image capture system that includes an optical module and an accessory that is configured for connection to the optical module such that, upon connection, the optical module and the accessory are in electrical communication, which facilitates the transmission of data and/or power therebetween. The optical module and the accessory include a variety of components, the distribution of which may be varied therebetween in order to alter the configuration and/or the weight of the optical module and the accessory (e.g., in order to increase the stability of the image capture system).

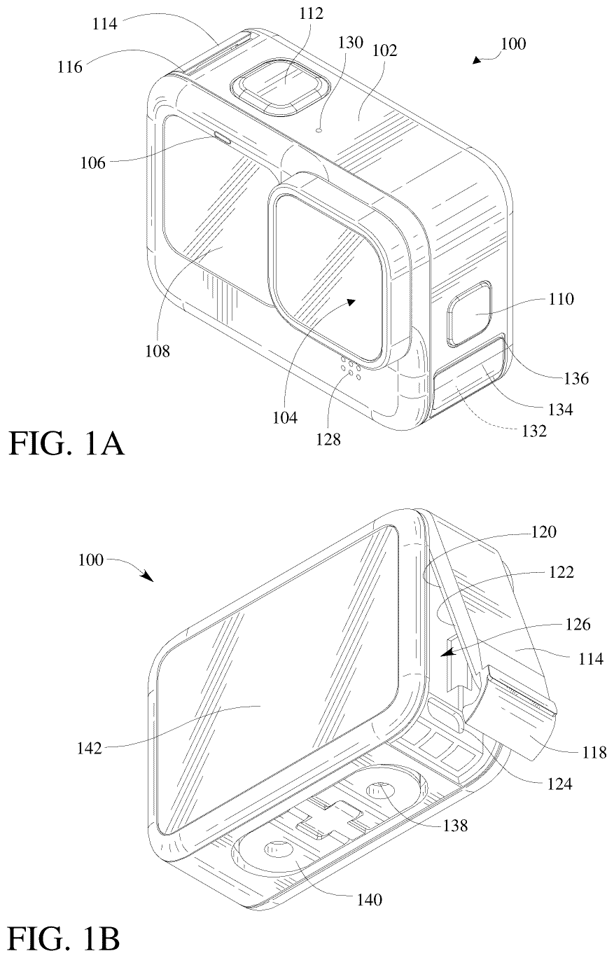

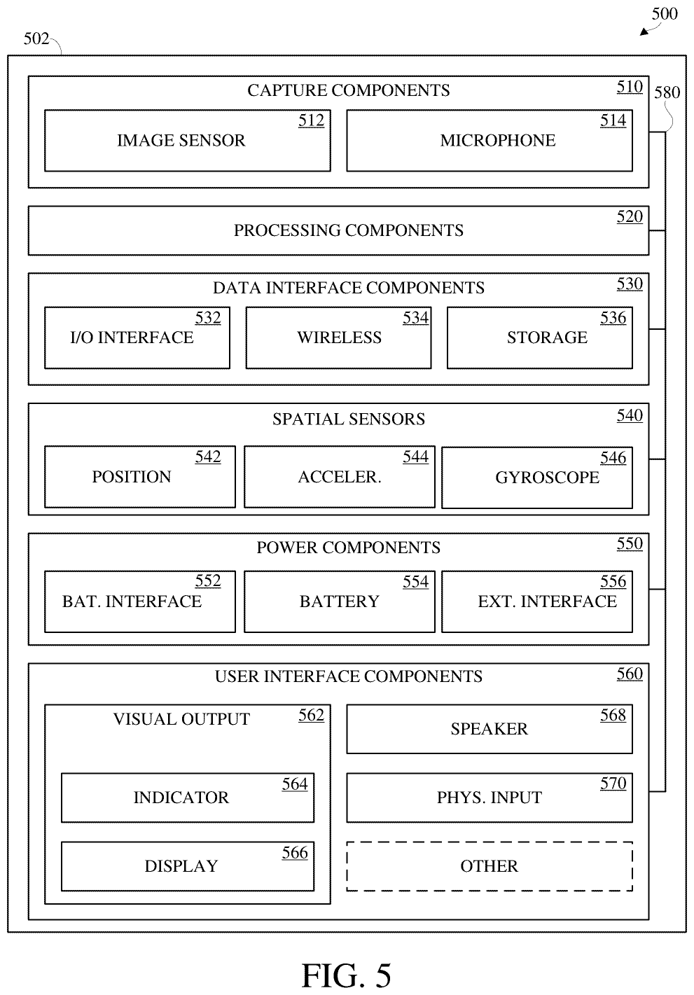

FIGS. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture apparatus 100 includes internal electronics, such as imaging electronics, power electronics, and the like, internal to the body 102 for capturing images and performing other functions of the image capture apparatus 100. An example showing internal electronics is shown in FIG. 5. The arrangement of the components of the image capture apparatus 100 shown in FIGS. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indicators structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be connected (secured) to the body 102 using the latch mechanism 118 that releasably engages (contacts) the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages (contacts) a flange (not shown) to provide an environmental seal and the battery interface 122 engages (contacts) the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptacle 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is positioned (located) behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects (secures) the image capture apparatus 100 to an external structure, such as a handle grip, another mount, or a securing device. The interconnect mechanism 140 includes folding protrusions configured to move between a collapsed (nested) configuration as shown in FIG. 1B and an extended (open) configuration. The folding protrusions of the interconnect mechanism 140 in the extended configuration may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

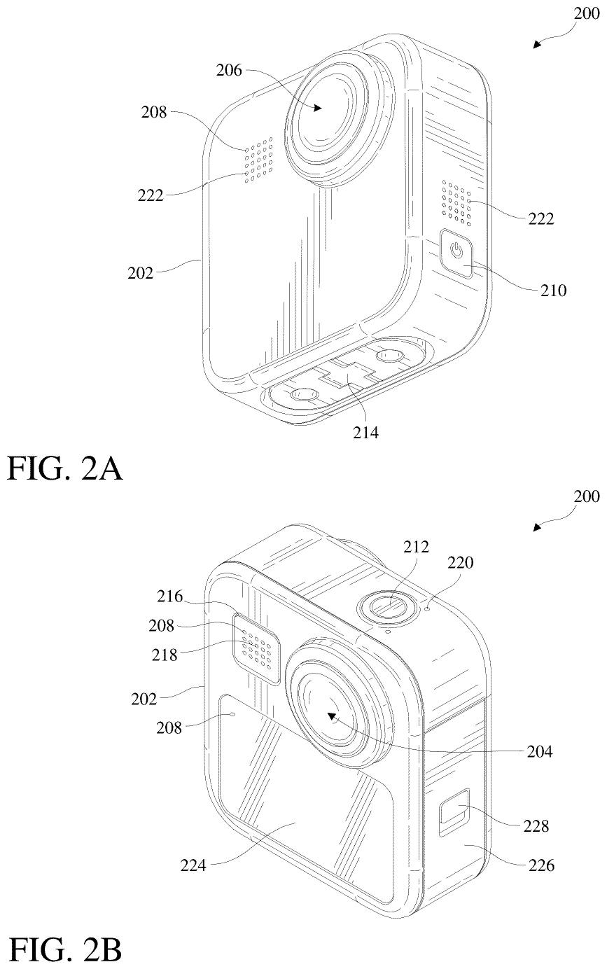

FIGS. 2A-2B illustrate another example of an image capture apparatus 200. The image capture apparatus 200 is similar to the image capture apparatus 100 shown in FIGS. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A-2B is an example, other arrangements of elements may be used.

The body 202 of the image capture apparatus 200 may be similar to the body 102 shown in FIGS. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A-2B, the image capture apparatus 200 may include other indictors structured on respective surfaces of the body 202.

As shown in FIGS. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 5.

As shown in FIGS. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is positioned (located) on a front surface of the body 202, a second audio component 220 is positioned (located) on a top surface of the body 202, and a third audio component 222 is positioned (located) on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

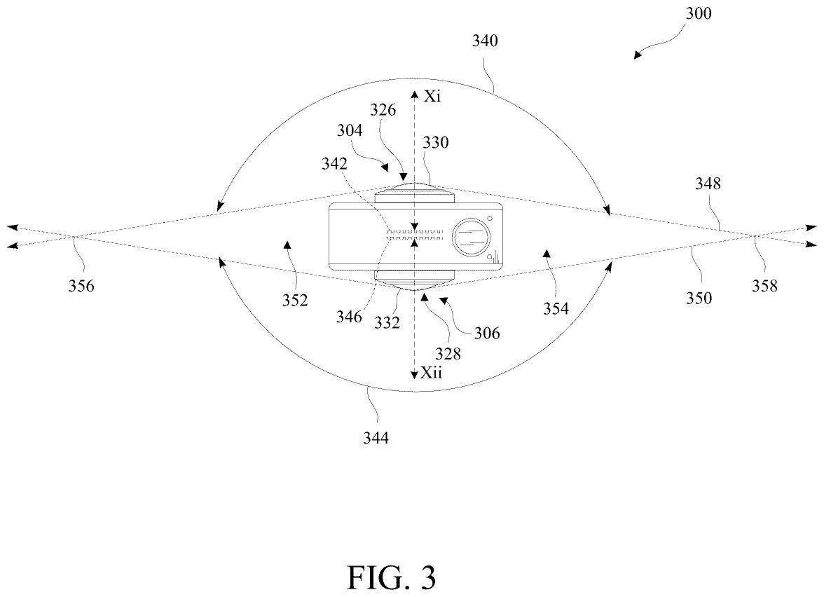

FIG. 3 is a top view of an image capture apparatus 300. The image capture apparatus 300 is similar to the image capture apparatus 200 of FIGS. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342. In the illustrated embodiment, the first lens 330 and the first image sensor 342 are integrated into a single unit, whereby the first image capture device 304 is configured as a first ISLA 326 that defines a first optical axis Xi.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346. In the illustrated embodiment, the second lens 332 and the second image sensor 346 are integrated into a single unit, whereby the second image capture device 306 is configured as a second ISLA 328 that defines a second optical axis Xii.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions (e.g., a forward direction and a rearward direction), and such that the image capture apparatus 300 may capture spherical images. The first image sensor 342 detects a first hyper-hemispherical image plane from light entering the first lens 330. The second image sensor 346 detects a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously detected by the respective image sensors 342, 346 may be combined to form a combined image, such as a spherical image. Generating a combined image may include correlating the overlapping regions detected by the respective image sensors 342, 346, aligning the captured fields-of-view 340, 344, and stitching the images together to form a cohesive combined image. Stitching the images together may include correlating the overlap points 356, 358 with respective locations in corresponding images detected by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images detected by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The ISLAs 326, 328 (e.g., the lenses 330, 332) may be aligned as shown (e.g., such that the optical axes Xi, Xii are coincident with each other), laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

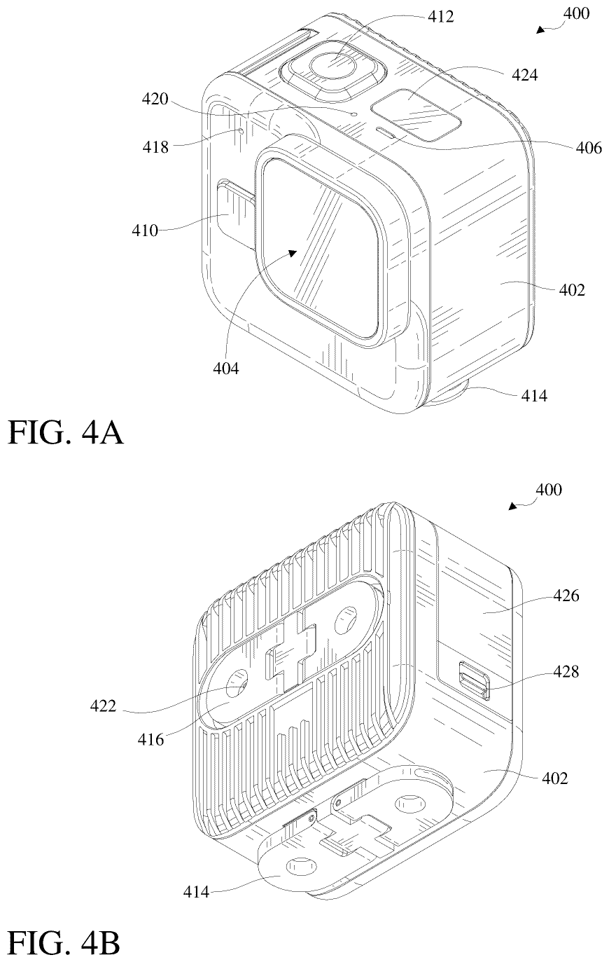

FIGS. 4A-4B illustrate another example of an image capture apparatus 400. The image capture apparatus 400 is similar to the image capture apparatus 100 shown in FIGS. 1A-1B and to the image capture apparatus 200 shown in FIGS. 2A-2B. The image capture apparatus 400 includes a body 402, an image capture device 404, an indicator 406, a mode button 410, a shutter button 412, interconnect mechanisms 414, 416, audio components 418, 420, 422, a display 424, and a door 426 including a release mechanism 428. The arrangement of the components of the image capture apparatus 400 shown in FIGS. 4A-4B is an example, other arrangements of elements may be used.

The body 402 of the image capture apparatus 400 may be similar to the body 102 shown in FIGS. 1A-1B. The image capture device 404 is structured on a front surface of the body 402. The image capture device 404 includes a lens and may be similar to the image capture device 104 shown in FIG. 1A.

As shown in FIG. 4A, the image capture apparatus 400 includes the indicator 406 on a top surface of the body 402. The indicator 406 may be similar to the indicator 106 shown in FIG. 1A. The indicator 406 may indicate a status of the image capture device 204. Although one indicator 406 is shown in FIGS. 4A, the image capture apparatus 400 may include other indicators structured on respective surfaces of the body 402.

As shown in FIGS. 4A, the image capture apparatus 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture apparatus 400 includes internal electronics (not expressly shown), such as imaging electronics, power electronics, and the like, internal to the body 402 for capturing images and performing other functions of the image capture apparatus 400. An example showing internal electronics is shown in FIG. 5.

As shown in FIGS. 4A-4B, the image capture apparatus 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIGS. 4A-4B, the image capture apparatus 400 includes the audio components 418, 420, 422 respectively structured on respective surfaces of the body 402. The audio components 418, 420, 422 may be similar to the microphones 128, 130, 132 and the speaker 138 shown in FIGS. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIGS. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture apparatus 400 includes the display 424 structured on a front surface of the body 402. The display 424 may be similar to the displays 108, 142 shown in FIGS. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture apparatus 400 may include multiple displays structured on respective surfaces of the body 402. In some implementations, the display 424 may be omitted or combined with another component of the image capture apparatus 200.

As shown in FIG. 4B, the image capture apparatus 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture apparatus 400 may include features or components other than those described herein, some features or components described herein may be omitted, or some features or components described herein may be combined. For example, the image capture apparatus 400 may include additional interfaces or different interface features, interchangeable lenses, cold shoes, or hot shoes.

FIG. 5 is a block diagram of electronic components in an image capture apparatus 500. The image capture apparatus 500 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A-1B, the image capture apparatus 200 shown in FIGS. 2A-2B, the image capture apparatus 300 shown in FIG. 3, or the image capture apparatus 400 shown in FIGS. 4A-4B, may be implemented as shown in FIG. 5.

The image capture apparatus 500 includes a body 502. The body 502 may be similar to the body 102 shown in FIGS. 1A-1B, the body 202 shown in FIGS. 2A-2B, or the body 402 shown in FIGS. 4A-4B. The body 502 includes electronic components such as capture components 510, processing components 520, data interface components 530, spatial sensors 540, power components 550, user interface components 560, and a bus 580.

The capture components 510 include an image sensor 512 for detecting images. Although one image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 detects light as image data and conveys the image data as electrical signals (image signals or image data) to the other components of the image capture apparatus 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with image detection by the image sensor 512. The microphone 514 may detect sound to receive audible commands to control the image capture apparatus 500. The microphone 514 may be similar to the microphones 128, 130, 132 shown in FIGS. 1A-1B, the audio components 218, 220, 222 shown in FIGS. 2A-2B, or the audio components 418, 420, 422 shown in FIGS. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture apparatus 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture apparatus 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture apparatus 500 and the memory card, such as for storing images, recorded audio, or both captured by the image capture apparatus 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture apparatus 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture apparatus 500, which may include obtaining, such as by receiving, temporal data, such as via a GPS signal. The accelerometer 544, which may be a three-axis accelerometer, may measure linear motion, linear acceleration, or both of the image capture apparatus 500. The gyroscope 546, which may be a three-axis gyroscope, may measure rotational motion, such as a rate of rotation, of the image capture apparatus 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture apparatus 500 for operating the image capture apparatus 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture apparatus 500. The battery interface 552 may be similar to the battery receptacle 126 shown in FIG. 1B. The external power interface 556 obtains or receives power from an external source, such as a wall plug or external battery, and distributes the power to the components of the image capture apparatus 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture apparatus 500, output, such as display or present, information to a user, or both receive input and output information, such as in accordance with user interaction with the image capture apparatus 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIGS. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIGS. 2A-2B, or the audio components 418, 420, 422 shown in FIGS. 4A-4B. Although one speaker 568 is shown in FIG. 5, the user interface components 560 may include multiple speakers. In some implementations, the speaker 568 may be omitted or combined with another component of the image capture apparatus 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture apparatus 500. The physical input interface 570 may be, for example, a button, a toggle, a switch, a dial, or a slider.

As shown in FIG. 5, the user interface components 560 include a broken line border box labeled “other” to indicate that components of the image capture apparatus 500 other than the components expressly shown as included in the user interface components 560 may be user interface components. For example, the microphone 514 may receive, or capture, and process audio signals to obtain input data, such as user input data corresponding to voice commands. In another example, the image sensor 512 may detect, receive, or otherwise process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

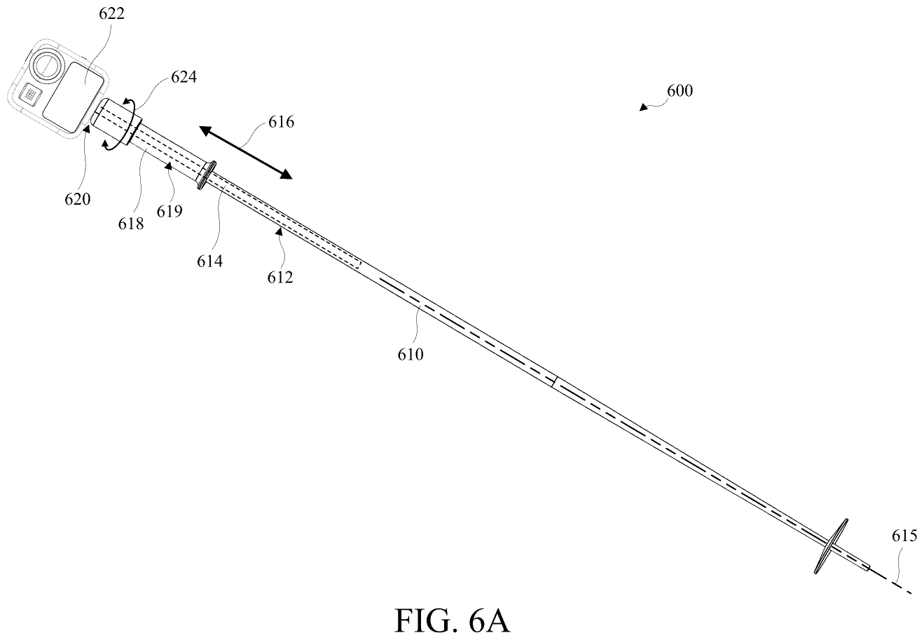

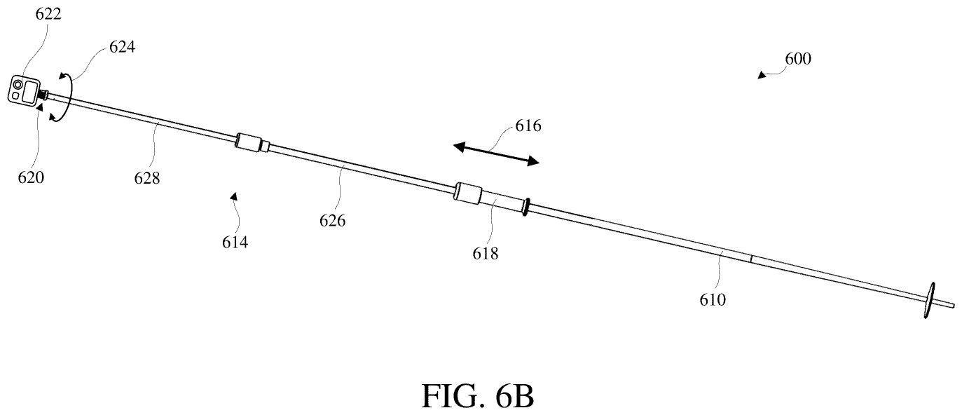

FIGS. 6A and 6B are perspective views of a ski pole assembly 600. The ski pole assembly 600 may include a ski pole 610 that defines a cavity 612 therein. An extension 614 may be at least partially received by the cavity 612 of the ski pole 610 and may be configured to move with respect to the ski pole 610. By way of example, the extension 614 may be configured to traverse the cavity along a longitudinal axis 615 of the ski pole 610 in a direction 616. As a result, the extension 614 may move in the direction 616 such that the extension 614 may move into and out of the ski pole 610 (e.g., into and out of the cavity 612 of the ski pole 610).

The extension 614 may be configured to be at least partially stored within the cavity 612 of the ski pole 610. The extension 614 may also be configured to extend from the ski pole 610 to increase an overall length of the ski pole assembly 600 as measured along the longitudinal axis 615 of the ski pole 610. For example, the extension 614 may move in the direction 616 between a collapsed position, as shown in FIG. 6A, and an extended position, as shown in FIG. 6B. In the collapsed position, the extension 614 may be located substantially or entirely within the cavity 612 of the ski pole 610.

In the extended position, the extension 614 may extend out of the cavity 612 in the direction 616 away from the ski pole 610. As a result, movement of the extension 614 with respect to the ski pole 610 may be telescoping in nature to increase the length of the ski pole assembly 600 as desired by a user while allowing the user to stow the extension 614 within the ski pole 610 when not in use. To facilitate such telescoping movement, a diameter of the extension 614 may be less than a diameter of the cavity 612 of the ski pole 610 such that the extension 614 may fit within the cavity 612 of the ski pole 610.

The ski pole assembly 600 may further include a grip 618. The grip 618 may surround a portion of the ski pole 610 and provide a user with means to comfortably grasp the ski pole 610 during use (e.g., during skiing). By way of example, the grip 618 may define a cavity 619 therein, whereby a portion of the ski pole 610 (e.g., an end portion of the ski pole 610) may be located within the cavity 619 of the grip 618 to secure the grip 618 to the ski pole 610. In certain implementations, an adhesive and/or fasteners may be utilized to secure the grip 618 to the ski pole 610.

The cavity 619 of the grip 618 may be coaxial with the cavity 612 of the ski pole 610 along the longitudinal axis 615 of the ski pole 610 and may extend along the longitudinal axis 615 of the ski pole 610. As a result, the extension 614 may be configured to be at least partially located within the cavity 619 of the grip 618 and/or the cavity 612 of the ski pole 610. Similarly, the extension 614 may be at least partially inserted into the grip 618 such that the extension 614 may be movably coupled to the grip 618. That is, the extension 614 may be movably coupled to the grip 618 to maintain connection between the extension 614 and the ski pole assembly 600 yet allow the extension 614 to be free of direct connection to the ski pole 610.

As a result, the extension 614 may freely move into and out of the cavity 612 of the ski pole 610, such as in the direction 616, and may be coupled to the ski pole 610 via the grip 618. Moreover, due to interconnecting the extension 614 and the ski pole 610 via the grip 618, the grip 618 and the extension 614 may be easily disconnected from the ski pole 610, thereby allowing for interchangeability with other grips and/or extensions. It should be noted that in certain implementations, the extension 614 may be directly coupled to the ski pole 610, such as by fasteners.

The ski pole assembly 600 may also include a mounting mechanism 620 to mount an attachment 622 to the ski pole 610. The mounting mechanism 620 may be configured to fixedly and/or removably secure the attachment 622 to the ski pole 610, thereby eliminating the need for the user to store or carry the attachment 622 separately from the ski pole 610.

By way of example, the attachment 622 may be a camera that may be similar to the image capture apparatus 100, the image capture apparatus 200, the image capture apparatus 300, the image capture apparatus 400, and the image capture apparatus 500 described above. The camera may be mounted to the ski pole 610 using the mounting mechanism 620 such that the camera may be used to capture images during skiing. The camera may be rotatably coupled to the extension 614 via the mounting mechanism 620 such that the camera may rotate in a direction 624 with respect to the extension 614 (e.g., in the direction 624 about the longitudinal axis 615). Additionally, the camera may move along the longitudinal axis 615 in the direction 616 based upon movement of the extension 614 with respect to the ski pole 610.

As a result, the camera may move in various directions such that a user may capture images from a desired viewpoint during skiing, all while maintaining connection between the camera and the ski pole 610. Thus, the user may capture images in a “hands free” manner without the need of additional accessories other than the ski pole 610.

To further illustrate the movability and flexibility of the ski pole assembly 600 based on a user's needs, FIG. 6B illustrates the extension 614 in the extended position. The extension 614 may include a first segment 626 and a second segment 628 slidably (e.g., telescopically) and/or pivotally coupled to one another. The first segment 626 may be slidably and/or pivotally coupled to the grip 618 that at least partially surrounds the cavity 612 of the ski pole 610. As described above, the first segment 626 may move with respect to the grip 618 in the direction 616 along the longitudinal axis 615 of the ski pole 610 into and out of the cavity 612 of the ski pole 610 (e.g., telescoping movement).

The first segment 626 may also define a cavity therein. As a result, the second segment 628 may be at least partially received and/or inserted into the cavity of the first segment 626, such as via movement of the second segment 628 with respect to the first segment 626 in the direction 616 (e.g., along a longitudinal axis of the first segment 626, which may be coaxial with the longitudinal axis 615 of the ski pole 610). As a result, the first segment 626 and the second segment 628 may also be telescoping in nature similar to the extension 614 and the ski pole 610. Therefore, the second segment 628 may collapse at least partially within the first segment 626 to further improve storage of the extension 614 when in the collapsed position.

Based on the above, the attachment 622 (e.g., the camera) may move in the direction 616 toward and/or away from the ski pole 610 and may also rotate in the direction 624, thereby allowing the user to modify a position of the attachment 622. Such a position may be maintained during use of the ski pole 610 (e.g., during skiing), thereby allowing for consistent positioning of the attachment 622 while still facilitating movement of the attachment 622 with respect to the ski pole 610. Additionally, the aforementioned adjustments may be components integrated into the ski pole assembly 600 to eliminate additional means for carrying the attachment and/or operating the attachment 622.

It should also be noted that while the attachment 622 is described as a camera herein, the ski pole assembly 600 may be used with any other types of attachments. For example, the attachment 622 may be or may include a sensor (e.g., temperature sensor, gyroscope, accelerometer, etc.), may be a mechanical component (e.g., an extension of the grip 618, a weight for counterbalancing the ski pole 610, a cup holder, a mobile phone holder, etc.), may be another component, or a combination thereof.

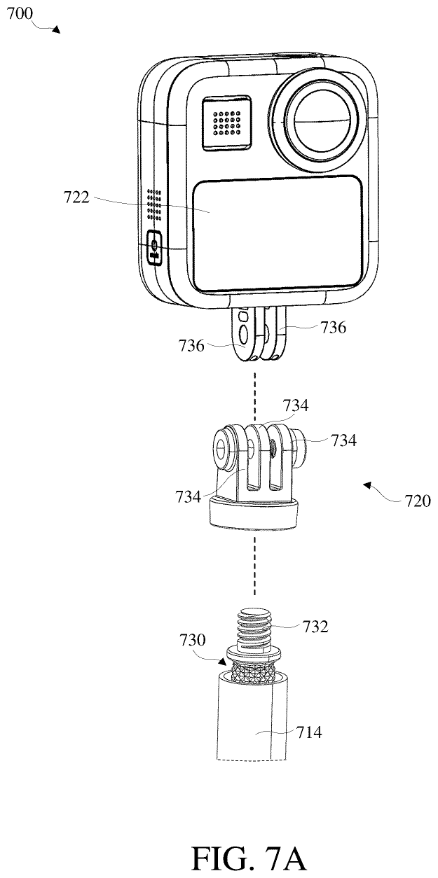

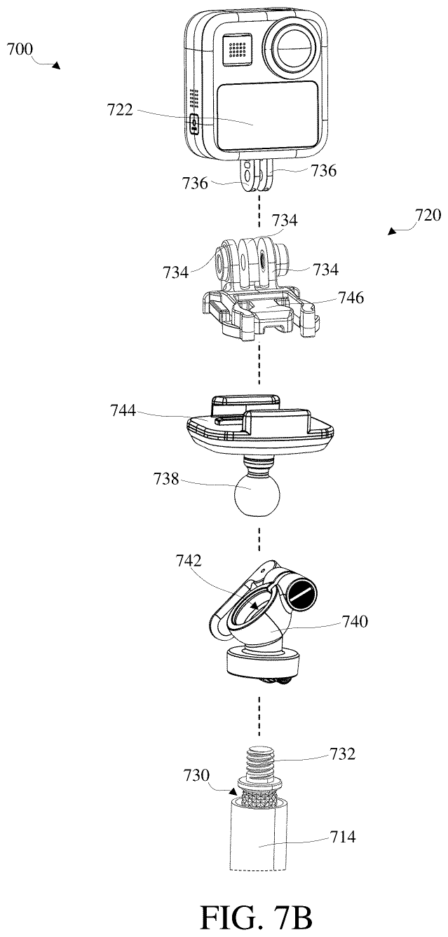

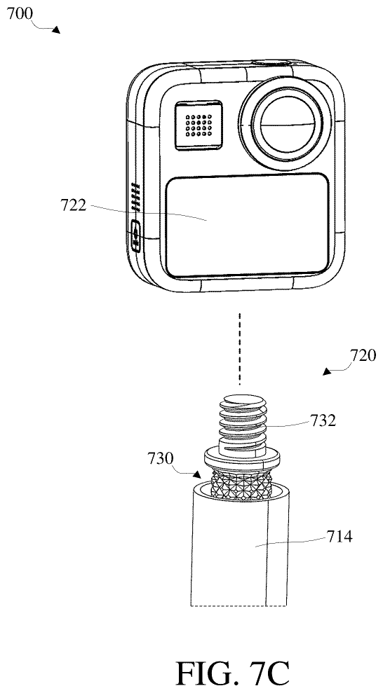

FIG. 7A illustrates a perspective view of an example of a ski pole assembly 700. The ski pole assembly may be similar to the ski pole assembly 600 described above. For illustrative purposes and simplicity, a ski pole (e.g., the ski pole 610) is intentionally omitted from FIG. 7A.

The ski pole assembly 700 may include an extension 714 that is similar to the extension 614 described above. That is, the extension 714 may be configured to be received by a cavity of the ski pole and may move with respect to the ski pole into and out of the cavity of the ski pole. The ski pole assembly 700 may further include a mounting mechanism 720 coupled to the extension 714 and configured to removably couple an attachment 722 (e.g., a camera) to the extension 714, thereby removably coupling the attachment 722 to the ski pole, as shown in FIGS. 6A and 6B.

By way of example, the extension 714 may include a first end that is configured to engage the ski pole and/or the grip (e.g., the ski pole 610 and/or the grip 618) and a second end that opposed the first end. The mounting mechanism 720 may be coupled to the second end of the extension 714 in any desired manner. For example, the extension 714 may define a cavity 730 therein that may receive and secure a fastener 732, such as a threaded bolt or screw. The mounting mechanism 720 may thus be coupled to the extension 714 by the fastener 732. Additionally, as described above, the fastener 732 may be rotatably coupled to the extension 714 via the fastener 732 such that the attachment 722 may rotate with respect to the extension 714.

To removably couple the attachment 722 to the extension 714, and thus the ski pole, the mounting mechanism 720 may include fingers 734 that are configured to interlock with another pair of fingers 736 associated with the attachment 722. For example, the fingers 734 may be a pair of fingers (or more than a pair of fingers, such as three or more fingers) that are configured to interlock with a pair of fingers that extend from the attachment 722. The fingers 734 may interlock with the fingers 736, such as by using a locking pin or fastener that may extend through both the fingers 734 of the mounting mechanism 720 and the fingers 736 of the attachment 722. As a result, the attachment 722 may be removably coupled to the extension 714 via the mounting mechanism 720. Additionally, such a configuration may allow for the attachment 722 to pivot or otherwise move with respect to the mounting mechanism 720, thereby further increasing the movability of the attachment 722 with respect to the ski pole.

FIG. 7B illustrates another example of the ski pole assembly 700. For illustrative purposes and simplicity, a ski pole (e.g., the ski pole 610) is intentionally omitted from FIG. 7B. The ski pole assembly 700 shown in FIG. 7B may be an alternative configuration of the ski pole assembly 700 shown in FIG. 7A. In particular, the mounting mechanism 720 shown in FIG. 7B may be, or may include, an alternative configuration compared to the mounting mechanism 720 shown in FIG. 7A.

As discussed above, the ski pole assembly 700 may include the extension 714 that may be movably coupled to a ski pole, such as the ski pole 610. The extension 714 may define the cavity 730 therein that may be configured to receive, and secure, the fastener 732. The fastener 732 may be configured to removably couple the mounting mechanism 720 to the extension 714 to removably couple the attachment 722 to the extension 714. As a result, the attachment 722 may be coupled to the ski pole via the mounting mechanism 720.

While FIG. 7A illustrates that the mounting mechanism 720 may include the fingers 734 that may engage the fingers 736 associated with the attachment 722 to secure the attachment 722 to the mounting mechanism 720, FIG. 7B illustrates an alternative means for securing the attachment 722 to the mounting mechanism 720.

In particular, FIG. 7B illustrates that the mounting mechanism 720 may include a ball portion 738 and a socket portion 740. The ball portion 738 may be configured to be removably coupled to the attachment 722 and may be coupled to the socket portion 740. For example, the ball portion 738 may be or may include a ball that may be received by a socket 742 of the socket portion 740. As such, when the ball portion 738 is coupled to the socket portion 740, the ball portion 738 and thus the attachment 722 may move (e.g., rotate, pivot, tilt, etc.) with respect to the socket portion 740, thereby providing an increased level of movement of the attachment 722 with respect to the ski pole.

Any desired configuration may be used to removably couple the attachment 722 to the ball portion 738. For example, the ball portion 738 may be coupled to, or integrally formed with, a quick release plate 744. The quick release plate 744 may include one or more channels, fingers, or other locking mechanisms that may releasably engage a portion of the attachment 722 to couple the attachment 722 to the ball portion 738. Alternatively, the mounting mechanism 720 may also include an intermediary bracket 746 that is configured to be releasably coupled to the attachment 722 such that the attachment 722 may be releasably coupled to the quick release plate 744.

By way of example, as discussed above, the attachment 722 may include a pair of fingers 736. The fingers 736 of the attachment 722 may be coupled to respective ones of the fingers 734 of the mounting mechanism 720, which may be located on, or extend from, the intermediary bracket 746. As a result, the attachment 722 may be coupled to the intermediary bracket 746 and the intermediary bracket 746 may engage (e.g., releasably couple to) the quick release plate 744. It should also be noted that the quick release plate 744 may include a release mechanism to disengage the attachment 722 and/or the intermediary bracket 746.

Alternatives to the quick release plate 744 may be used in addition to, or in lieu of, the quick release plate 744 as described above. For example, the quick release plate 744 may be or may include a magnetic surface to magnetically couple the attachment 722 to the ball portion 738. Similarly, one or more fasteners may be used in lieu of the quick release plate 744 to secure the attachment 722 to the ball portion 738.

FIG. 7C illustrates another example of the ski pole assembly 700. For illustrative purposes and simplicity, a ski pole (e.g., the ski pole 610) is intentionally omitted from FIG. 7C. The ski pole assembly 700 shown in FIG. 7C may be an alternative configuration of the ski pole assembly 700 shown in FIG. 7A and the ski pole assembly 700 shown in FIG. 7B. In particular, the mounting mechanism 720 shown in FIG. 7C may be, or may include, an alternative configuration compared to the mounting mechanism 720 shown in FIG. 7A and the mounting mechanism 720 shown in FIG. 7B.

As discussed above, the ski pole assembly 700 may include the extension 714 that may be movably coupled to a ski pole, such as the ski pole 610. The extension 714 may define the cavity 730 therein that may be configured to receive and secure the fastener 732. The fastener 732 may be configured to removably couple the mounting mechanism 720 to the extension 714 to removably couple the attachment 722 to the extension 714. As a result, the attachment 722 may be coupled to the ski pole via the mounting mechanism 720.

While FIGS. 7A and 7B illustrate that the mounting mechanism 720 may include an interconnecting component (e.g., the fingers 734, the ball portion 738, the socket portion 740, etc.) the mounting mechanism 720 may be free of an interconnecting component. For example, as shown in FIG. 7C, the attachment 722 may be directly coupled to the extension 714 via the fastener 732. That is, the attachment 722 may include or may define a receiving portion (e.g., a threaded hole) that may engage the fastener 732 to removably secure the attachment 722 to the extension 714. In such a case, the attachment 722 may be fixedly coupled to the extension 714 compared to the examples shown in FIGS. 7A and 7B. For example, the attachment 722 may be constrained to only rotation with respect to the extension 714 and may prevent tilting and/or sliding of the attachment 722 with respect to the extension 714.

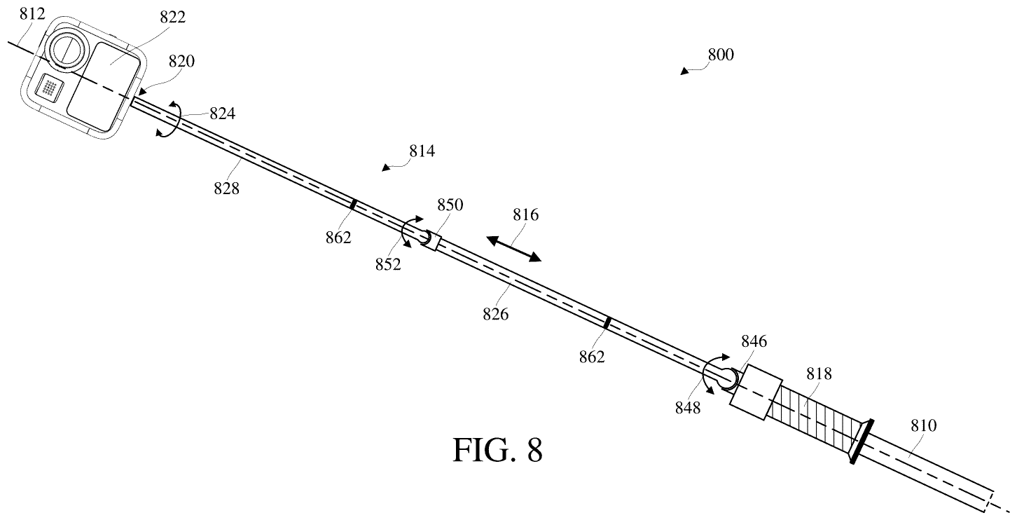

FIG. 8 illustrates another example of a ski pole assembly 800. The ski pole assembly 800 may be similar to the ski pole assembly 600 shown in FIGS. 6A and 6B and the ski pole assembly 700 shown in FIGS. 7A-7C.

The ski pole assembly 800 may include a ski pole 810 that extends along a longitudinal axis 812. An extension 814, which may be similar to the extension 614 and the extension 714 described above, may be movably coupled to the ski pole 810. For example, the extension 814 may move with respect to the ski pole 810 in a direction 816 towards and away from the ski pole 810 to increase and/or decrease a length of the ski pole assembly 800 as measured along the longitudinal axis 812 of the ski pole 810. As described above, the extension 814 may extend into a cavity defined by the ski pole 810 to facilitate storing of the extension 814 within the ski pole 810. For illustrative purposes, the extension 814 shown in FIG. 8 is in an extended position, in which the extension 814 protrudes from the ski pole 810.

The extension 814 may be configured to extend through a grip 818 coupled to the ski pole 810, such as through a cavity defined by the grip 818. Additionally, the extension 814 may be movably coupled to the grip 818 such that the extension 814 may move with respect to the grip 818 and/or the ski pole 810 yet remain coupled to the skip pole 810 via the grip 818.

The extension 814 may include, or may be coupled to, a mounting mechanism 820. The mounting mechanism 820 may be located anywhere along the extension 814, such as near an end of the extension 814 that is located farthest from the grip 818 when in the extended position. The mounting mechanism 820 may be or may include any configuration, such as a finger mechanism as shown in FIG. 7A or a ball and socket mechanism as shown in FIG. 7B. Similarly, the mounting mechanism 820 may be coupled to the extension 814 via one or more fasteners, such as the one shown in FIG. 7C.

In any of the above configurations, the mounting mechanism 820 may be configured to secure an attachment 822, such as a camera, to the extension 814, thereby coupling the attachment 822 to the ski pole 810. The attachment 822 may be movably coupled to the extension 814 via the mounting mechanism 820. For example, the attachment 822 may be configured to rotate with respect to the extension 814 in a direction 824 about the longitudinal axis 812 of the ski pole 810.

To provide additional freedom of movement to the attachment 822, the extension 814 may include a first segment 826 movably coupled to a second segment 828. The first segment 826 and the second segment 828 may be telescoping in nature, as described above with respect to the extension 614. That is, for example, the second segment 828 may be configured to extend into a cavity of the first segment 826 and may be stored within the first segment 826 in a retracted position. As a result, the first segment 826 and the second segment 828 may be collapsed and stored within the ski pole 810 and/or the grip 818.

As discussed above, the extension 814 may move in the direction 816 with respect to the ski pole 810 along the longitudinal axis 812 of the ski pole 810. To provide further movement of the attachment 822 with respect to the ski pole 810, the first segment 826 may be coupled to the grip 818 and/or the ski pole 810 by a first joint 846. The first joint 846 may be a ball joint or other type of joint that facilitates movement (e.g., rotation, tiling, etc.) of the first segment 826—and thus the second segment 828 and the attachment 822—in a direction 848 with respect to the ski pole 810. However, the direction 848 is intended for illustrative purposes and any type of movement of the first segment 826 with respect to the ski pole 810 may be possible.

Similarly, the second segment 828 may be coupled to the first segment 826 by a second joint 850. The second joint 850 may be similar to the first joint 846 or different from the first joint 846. For example, the second joint 850 may also be a ball joint or other type of joint that facilitates movement (e.g., rotation, tilting, etc.) of the second segment 828—and thus the attachment 822—in a direction 852 with respect to the first segment 826. As such, the attachment 822 may be oriented at any desired angle with respect to the ski pole 810 such that a user may position the attachment 822 with a desired orientation.

Such a position may also be maintained (i.e., “locked”) during use of the ski pole 810 (e.g., during skiing). For example, the position of the extension 814 may be locked to orient a camera in a desired direction to capture images of the skier while skiing.

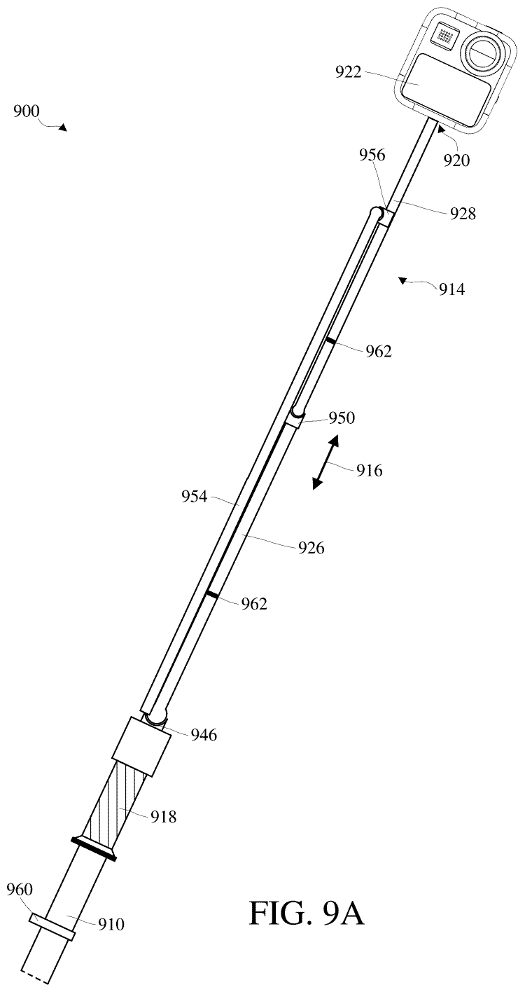

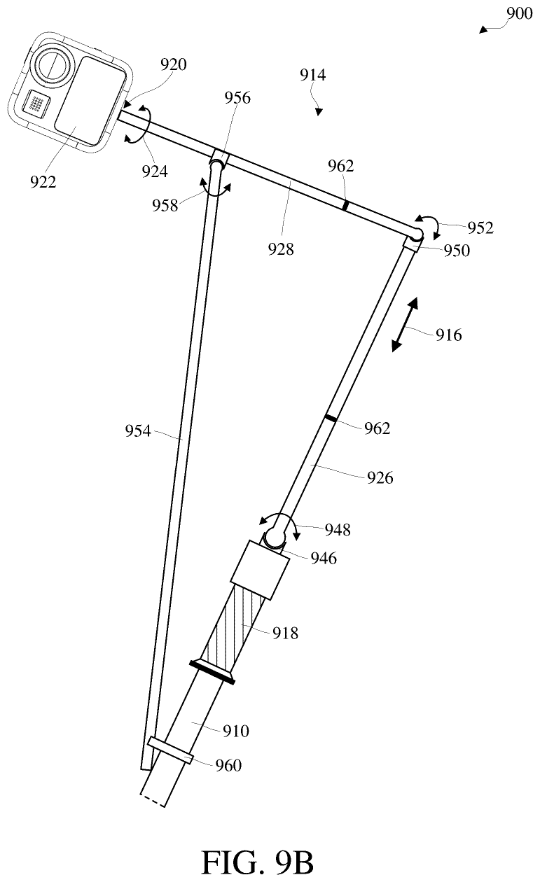

FIGS. 9A and 9B illustrate another example of a ski pole assembly 900. The ski pole assembly 900 may be similar to the ski pole assembly 600 shown in FIGS. 6A and 6B, the ski pole assembly 700 shown in FIGS. 7A-7C, and the ski pole assembly 800 shown in FIG. 8.

The ski pole assembly 900 may include a ski pole 910. An extension 914 may be movably (e.g., slidably and/or rotatably) coupled to the ski pole 910. The extension 914 may move similar to the extension 614 shown in FIGS. 6A and 6B and the extension 814 shown in FIG. 8. For example, as described above, the extension 914 may extend into and out of a cavity defined by the ski pole 910 in a direction 916. For illustrative purposes, the extension 914 shown in FIGS. 9A and 9B is in an extended position, in which the extension 914 protrudes from the ski pole 910.

The extension 914 may be configured to extend through a grip 918 coupled to the ski pole 910, such as through a cavity defined by the grip 918. Additionally, the extension 914 may be movably coupled to the grip 918 such that the extension 914 may move with respect to the grip 918 and/or the ski pole 910 yet remain coupled to the skip pole 910 via the grip 918.

The extension 914 may include, or may be coupled to, a mounting mechanism 920. The mounting mechanism 920 may be or may include any configuration, such as a finger mechanism as shown in FIG. 7A or a ball and socket mechanism as shown in FIG. 7B. Similarly, the mounting mechanism 920 may be coupled to the extension 914 via one or more fasteners, such as the one shown in FIG. 7C.

In any of the above configurations, the mounting mechanism 920 may be configured to secure an attachment 922, such as a camera, to the extension 914, thereby coupling the attachment 922 to the ski pole 910. The attachment 922 may be movably coupled to the extension 914 via the mounting mechanism 920. For example, the attachment 922 may be configured to rotate with respect to the extension 914 in a direction 924.

To provide additional freedom of movement to the attachment 922, the extension 914 may include a first segment 926 movably coupled to a second segment 928. The first segment 926 and the second segment 928 may be telescoping in nature, as described above with respect to the extension 914 such that the first segment 926 and the second segment 928 may move in the direction 916 with respect to the ski pole 910. As a result, the first segment 926 and the second segment 928 may be collapsed and stored within the ski pole 910 and/or the grip 918.

The first segment 926 may be coupled to the grip 918 and/or the ski pole 910 by a first joint 946. The first joint 946 may be a ball joint or other type of joint that facilitates movement (e.g., rotation, tiling, etc.) of the first segment 926—and thus the second segment 928 and the attachment 922—in a direction 948 with respect to the ski pole 910. However, the direction 948 is intended for illustrative purposes and any type of movement of the first segment 926 with respect to the ski pole 910 may be possible.

Similarly, the second segment 928 may be coupled to the first segment 926 by a second joint 950. The second joint 950 may be similar to the first joint 946 or different from the first joint 946. For example, the second joint 950 may also be a ball joint or other type of joint that facilitates movement (e.g., rotation, tilting, etc.) of the second segment 928—and thus the attachment 922—in a direction 952 with respect to the first segment 926. As such, the attachment 922 may be oriented at any desired angle with respect to the ski pole 910 such that a user may position the attachment 922 with a desired orientation.

Such a position may also be maintained (i.e., “locked”) during use of the ski pole 910 (e.g., during skiing). The position of the extension 914 may be locked to orient a camera in a desired direction to capture images of the skier while skiing. By way of example, the ski pole assembly 900 may include a support arm 954 pivotally coupled to the extension 914 by a third joint 956, whereby the support arm 954 may move (rotate, tilt, etc.) in a direction 958 with respect to the extension 914. To maintain a position of the attachment 922, the support arm 954 may be configured to couple to the ski pole 910, such as via a connector 960 located on or coupled to the ski pole 910. As a result, the support arm 954 may stabilize the extension 914 in its position and prevent unwanted movement of the extension 914 during use of the ski pole 910.

The support arm 954 may move in the direction 958 between a collapsed position, as shown in FIG. 9A, and an extended position, as shown in FIG. 9B. In the collapsed position, the support arm 954 may be substantially parallel to the extension 914 such that the support arm 954 may also be received by the cavity defined by the ski pole 910. That is, the support arm 954 may be stored in the cavity of the ski pole 910 along with the extension 914 when not in use.

The support arm 954 may be coupled to the ski pole 910 and the extension 914 in any desired positions. For example, the extension 914 may include a first end that may be coupled to the mounting mechanism 920 and a second end that opposes the first arm and is coupled to the grip 918 and/or the ski pole 910. The support arm 954 may be pivotally coupled to the extension 914 between the first end and the second end. For example, the support arm 954 may be coupled to the first segment 926 and/or the second segment 928.

It should also be noted that the support arm 954 may, in certain configurations, be disconnected from the extension 914 such that the support arm 954 may be coupled to the ski pole 910 and stored adjacent to the ski pole 910. For example, the support arm 954 may be stowed adjacent to an exterior surface of the ski pole 910 instead of within the cavity of the ski pole 910.

To provide further functionality to the ski pole assembly 900, the extension 914 may include one or more indicator lines 962 located along the first segment 926 and/or the second segment 928. The indicator lines 962 may indicate a position of the extension 914 with respect to the ski pole 910 such that the attachment 922 may counterbalance the ski pole 910 to provide a better use experience while skiing. That is, the indicator lines 962 may indicate extension points for the extension 914 to extend out of the ski pole 910 and proper counterbalance the ski pole 910 for proper use during skiing.

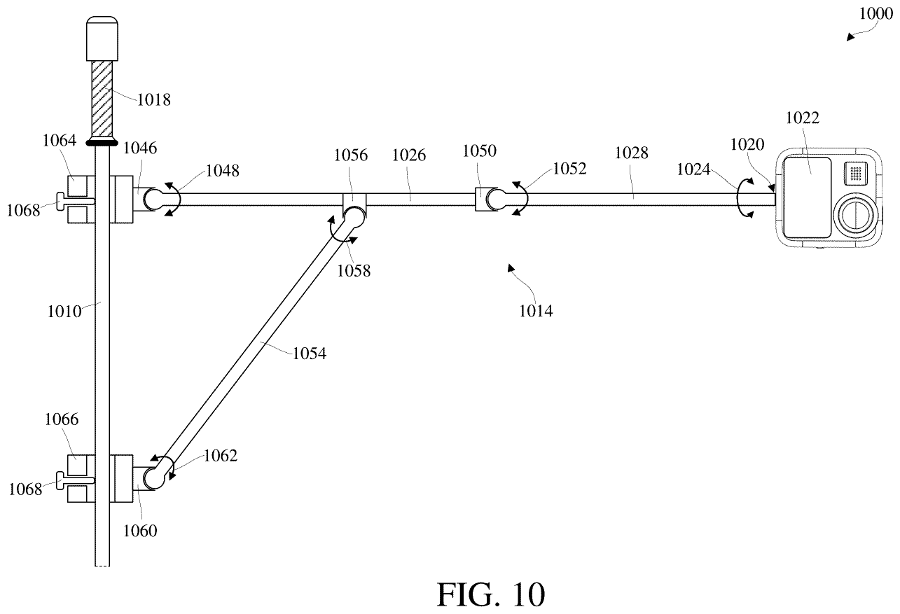

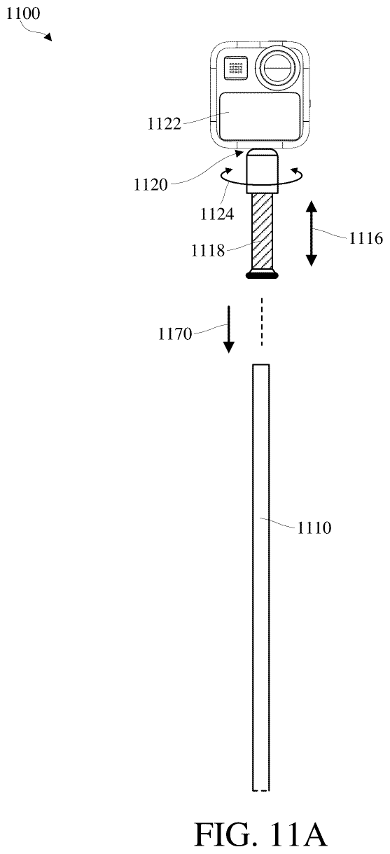

FIG. 10 illustrates another example of a ski pole assembly 1000. The ski pole assembly 1000 may be similar to the ski pole assembly 600 shown in FIGS. 6A and 6B, the ski pole assembly 700 shown in FIGS. 7A-7C, the ski pole assembly 800 shown in FIG. 8, and the ski pole assembly 900 shown in FIG. 9.

The ski pole assembly 1000 may include a ski pole 1010 and an extension 1014 coupled to the ski pole 1010. A grip 1018 may also be coupled to the ski pole 1010 to provide a user a more comfortable location to grasp the ski pole 1010. Additionally, the ski pole assembly 1000 may include a mounting mechanism 1020 coupled to the extension and configured to removably secure an attachment 1022, such as a camera, to the ski pole 1010. The attachment 1022 may be rotatably coupled to the extension 1014 via the mounting mechanism 1020 such that the attachment 1022 may rotate in a direction 1024 with respect to the extension 1014.

The extension 1014 may include one or more portions. For example, the extension 1014 may include a first segment 1026 movably coupled to a second segment 1028. The first segment 1026 may move with respect to the ski pole 1010 about a first joint 1046, such as in a direction 1048. The first segment 1026 may be movably coupled to the second segment 1028 via a second joint 1050 such that the second segment 1028 may move with respect to the first segment 1026, such as in a direction 1052. As a result, various positions of the attachment 1022 with respect to the ski pole 1010 may be possible.

Such a position may also be maintained (i.e., “locked”) during use of the ski pole 1010 (e.g., during skiing). The position of the extension 1014 may be locked to orient a camera in a desired direction to capture images of the skier while skiing. By way of example, the ski pole assembly 1000 may include a support arm 1054 pivotally coupled to the extension 1014 by a third joint 1056, whereby the support arm 1054 may move (rotate, tilt, etc.) in a direction 1058 with respect to the extension 1014. To maintain a position of the attachment 1022, the support arm 1054 may be configured to couple to the ski pole 1010, such as via a fourth joint 1060 located on or coupled to the ski pole 1010. The support arm 1054 may move in a direction 1062 with respect to the ski pole 1010 via the fourth joint 1060. As a result, the support arm 1054 may stabilize the extension 1014 in its position and prevent unwanted movement (e.g., vibration) of the extension 1014 during use of the ski pole 1010.

The extension 1014 may be coupled to the ski pole 1010 via one or more mounting brackets, such as a first mounting bracket 1064 and a second mounting bracket 1066. The first mounting bracket 1064 and the second mounting bracket 1066 may be secured to the ski pole in any desired manner, such as via one or more fasteners 1068 (e.g., locking pin, screw, etc.) that engage the ski pole 1010 and maintain a location of the ski pole 1010 received by a channel of the mounting brackets.

The first mounting bracket 1064 may be coupled to the first segment 1026 of the extension 1014 via the first joint 1046 and the second mounting bracket 1066 may be coupled to the support arm 1054 via the fourth joint 1060. As such, the mounting brackets may removably secure the extension to the ski pole 1010 and facilitate movement of the attachment 1022 via the extension 1014 to a desired position.

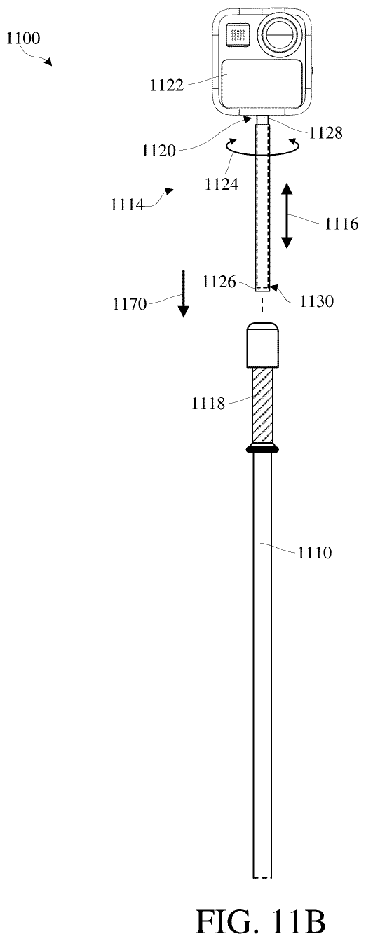

FIGS. 11A and 11B illustrate other examples of a ski pole assembly 1100. The ski pole assembly 1100 may be similar to the ski pole assembly 600 shown in FIGS. 6A and 6B, the ski pole assembly 700 shown in FIGS. 7A-7C, the ski pole assembly 800 shown in FIG. 8, and the ski pole assembly 900 shown in FIG. 9.

The ski pole assembly 1100 may include a ski pole 1110 and an extension 1114 movably coupled to the ski pole 1110. The extension 1114 may be configured to move in a direction 1116, such as along a longitudinal axis of the ski pole 1110, with respect to the ski pole 1110. The extension 1114 may be configured to be stored within a cavity of the ski pole 1110.

The ski pole assembly 1100 may also include a grip 1118 that may be coupled to the ski pole 1110. The grip 1118 may be removably coupled to the ski pole 1110. For example, the grip 1118 may be interchangeable with one or more additional grips. The grip 1118 may be coupled to the ski pole 1110 by moving the grip 1118 in a direction 1170 to secure a portion of the ski pole 1110, the extension 1114, or both within a cavity defined by the grip 1118. However, other mounting techniques may also be possible.

The ski pole assembly 1100 may also include a mounting mechanism 1120 that may be configured to directly and/or indirectly secure an attachment 1122, such as a camera, to the ski pole 1110. The attachment 1122 may be movably coupled to the ski pole 1110 via the mounting mechanism 1120 such that the attachment 1122 may rotate in a direction 1124 with respect to the ski pole 1110.

As shown in FIG. 11A, the mounting mechanism 1120 may be coupled to the grip 1118 such that the grip 1118 and the mounting mechanism 1120 may be disconnected from the ski pole 1110 as an assembly. In such a configuration, the extension 1114, as discussed further below, may be stored or otherwise contained within and connected to the grip 1118. For example, the extension 1114 may be movably coupled to the grip 1118 and configured to move in a direction 1116 with respect to the grip 1118. Therefore, the grip 1118, the extension 1114, and the mounting mechanism 1120 may be disconnected from the ski pole 1110 and interchanged with one or more additional accessories of the ski pole 1110, such as another grip or attachment.

Alternatively, or additionally, the extension 1114 may be disconnected from the grip 1118 such that the extension 1114 and the mounting mechanism 1120 may be disconnected together from the grip 1118. For example, as shown in FIG. 11B, the extension 1114 may include a first segment 1126 movably coupled to a second segment 1128, whereby the second segment 1128 may move into and out of a cavity 1130 defined by the first segment 1126. The first segment 1126 may removably couple to the grip by inserting the first segment 1126 into a cavity of the grip 1118, such as in the direction 1170.

Therefore, based on the above, the ski pole assembly 1100 may provide further customization to the ski pole 1110. That is, the grip 1118, the extension 1114, the mounting mechanism 1120, the attachment 1122, or a combination thereof may be removably coupled to the ski pole 1110 to facilitate easy connection and disconnection from the ski pole 1110. Similarly, based on the configurations shown in FIGS. 11A and 11B, some or all of the components coupled to the ski pole 1110 may be interconnected to facilitate connection and/or disconnection of such components together (e.g., as a sub-assembly). As a result, connection of the attachment 1122 to the ski pole 1110 may be completed with ease.

The methods and techniques of the ski pole mount described herein, or aspects thereof, may be implemented by an image capture apparatus, or one or more components thereof, such as the image capture apparatus 100 shown in FIGS. 1A-1B, the image capture apparatus 200 shown in FIGS. 2A-2B, the image capture apparatus 300 shown in FIG. 3, the image capture apparatus 400 shown in FIGS. 4A-4B, or the image capture apparatus 500 shown in FIG. 5. The methods and techniques of the ski pole mount described herein, or aspects thereof, may be implemented by an image capture device, such as the image capture device 104 shown in FIGS. 1A-1B, one or more of the image capture devices 204, 206 shown in FIGS. 2A-2B, one or more of the image capture devices 304, 306 shown in FIG. 3, the image capture device 404 shown in FIGS. 4A-4B, or an image capture device of the image capture apparatus 500 shown in FIG. 5.

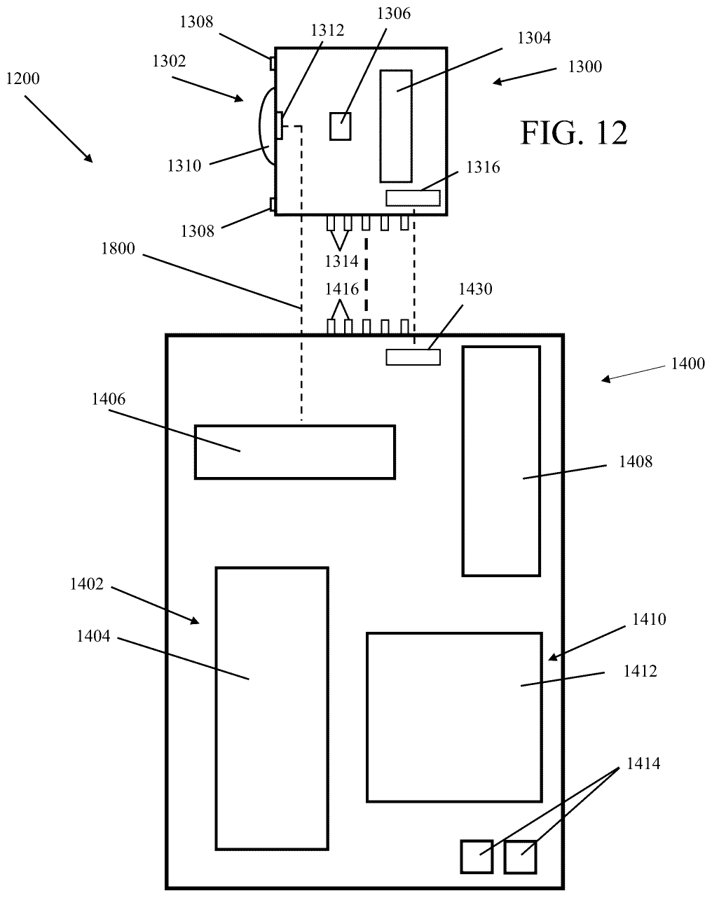

With reference now to FIG. 12, a schematic view of an image capture system 1200 is provided, which includes an optical module 1300 and a (first) accessory 1400.

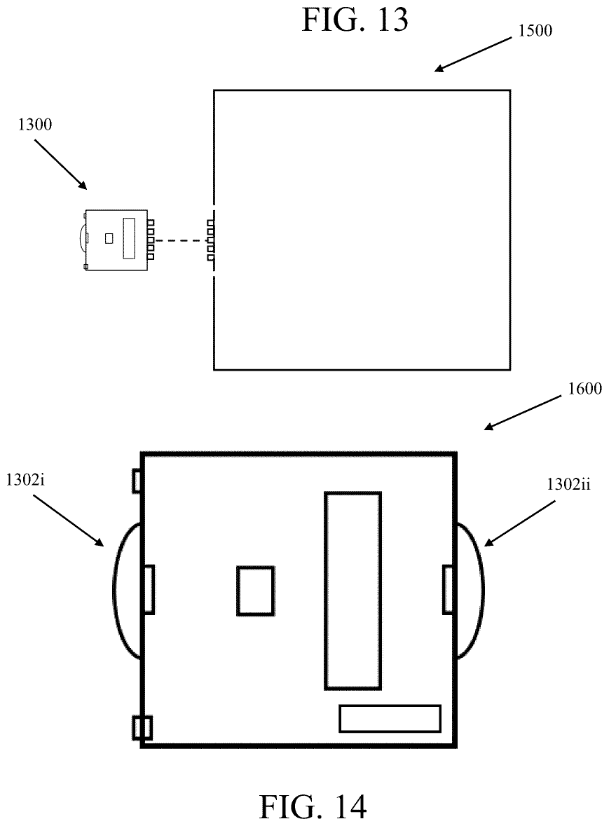

The optical module 1300 includes: an ISLA 1302; one or more (first) heat sinks 1304, which distribute thermal energy (heat) away from the ISLA 1302; an inertial measurement unit (IMU) 1306; and one or more microphones 1308. Although shown in connection with the accessory 1400 in FIG. 12, FIG. 13 is a schematic view illustrating use of the optical module 1300 with an image capture apparatus 1500, which is configured to removably receive the optical module 1300.

The ISLA 1302 includes a lens 1310 and an image sensor 1312, which are similar (or identical) to the lenses 330, 332 (FIG. 3) and the image sensors 342, 346 discussed above, respectively. Although shown as including a single ISLA 1302 in FIG. 12, FIG. 14 is a schematic view of an omni-directional (spherical) embodiment of the optical module, which is identified by the reference character 1600 and includes a pair of ISLAs 1302i, 1302ii that are oriented (face) in opposite directions, as discussed above in connection with the image capture apparatuses 200 (FIGS. 2A, 2B), 300 (FIG. 3).

Although the IMU 1306 and the microphone(s) 1308 are illustrated as components of the optical module 1300 in FIG. 12, embodiments are also envisioned in which the IMU 1306 and/or the microphone(s) 1308 may be located within the accessory 1400, as described in further detail below, as are embodiments in which the IMU 1306 and/or the microphone(s) 1308 may be omitted altogether (e.g., to reduce the cost of the image capture system 1200).

The accessory 1400 is configured for (direct) connection to the optical module 1300, whereupon electrical communication is established therebetween to facilitate the (bidirectional) transmission of data and/or power. The accessory 1400 includes: a power source 1402 (e.g., a battery 1404); a SoC (system on chip) 1406; one or more (second) heat sinks 1408, which distribute thermal energy (heat) away from the SoC 1406; a display 1410 (e.g., an LED screen 1412 or other such user interface); and one or more operational buttons 1414 (e.g., a shutter button, a power button, etc.) to control operation of the image capture system 1200 (e.g., i.e., the optical module 1300 and/or the accessory 1400). Including the power source 1402, the SoC 1406, the heat sink(s) 1408, the display 1410, and the operational button(s) 1414 in the accessory 1400 allows for a reduction in the size and the overall weight of the optical module 1300, which increases not only user comfort, but the stability of the image capture system 1200 by rendering the image capture system 1200 less top-heavy. For example, depending upon the materials utilized in construction of the optical module 1300 and the accessory 1400, the overall complexity of the image capture system 1200 and the capabilities thereof, etc., it is envisioned that approximately 60% to approximately 95% of the overall weight of the image capture system 1200 may be included in the accessory 1400.

In the illustrated embodiment, the optical module 1300 and the accessory 1400 are configured for releasable connection. Embodiments in which the optical module 1300 and the accessory 1400 may be fixedly (i.e., non-releasably) connected are also envisioned herein, however, and would not be beyond the scope of the present disclosure.

It is envisioned that the optical module 1300 may be configured for connection to the accessory 1400 and/or the image capture apparatus 1500 in any manner suitable for the intended purpose of facilitating the communication of data and/or power therebetween. For example, in the illustrated embodiment, the optical module 1300 and the accessory 1400 include corresponding connector pins 1314, 1416, respectively.

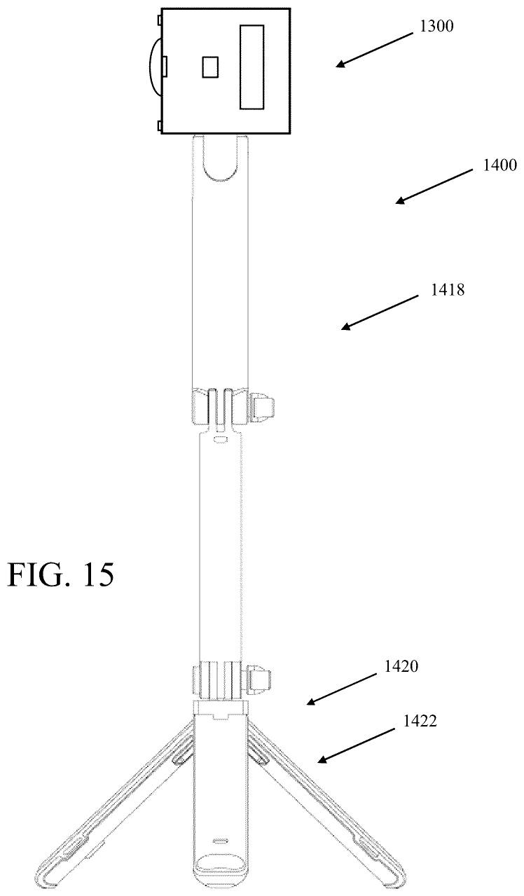

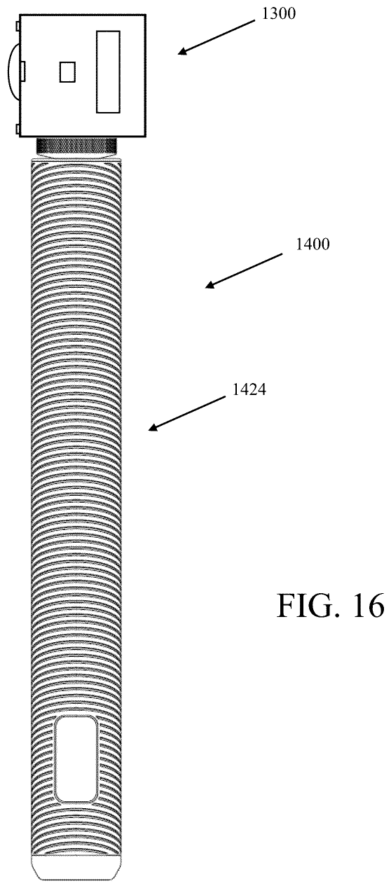

The accessory 1400 may be configured in any manner suitable for the intended purpose of supporting the optical module 1300. For example, FIG. 15 is a front, perspective view of one embodiment of the accessory 1400, which is configured as a handheld apparatus 1418 including a grip 1420 that is reconfigurable into a tripod 1422, and FIG. 16 is a front, perspective view of another embodiment of the accessory 1400, which is configured as a selfie stick 1424.

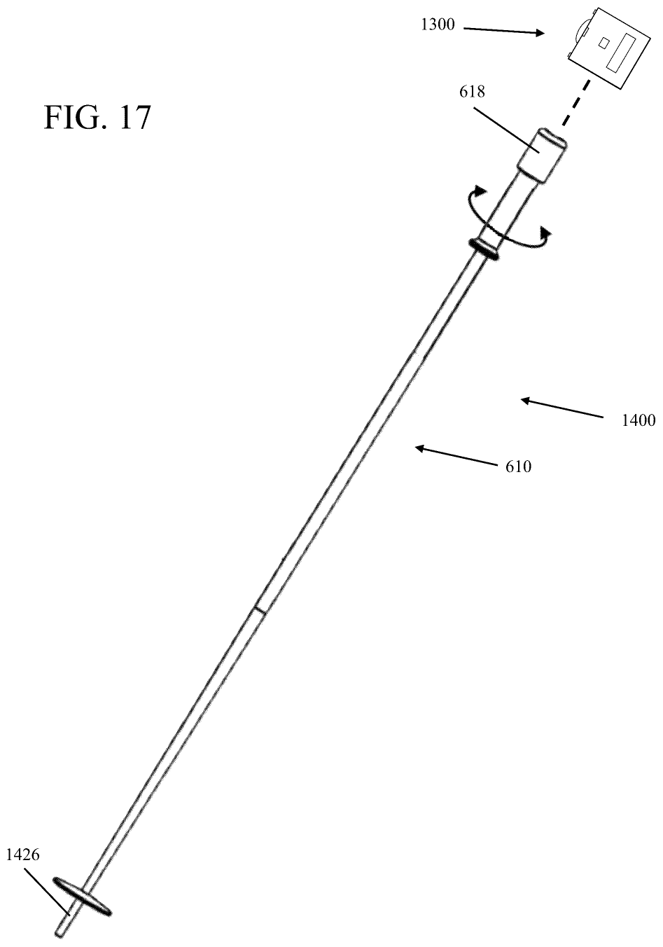

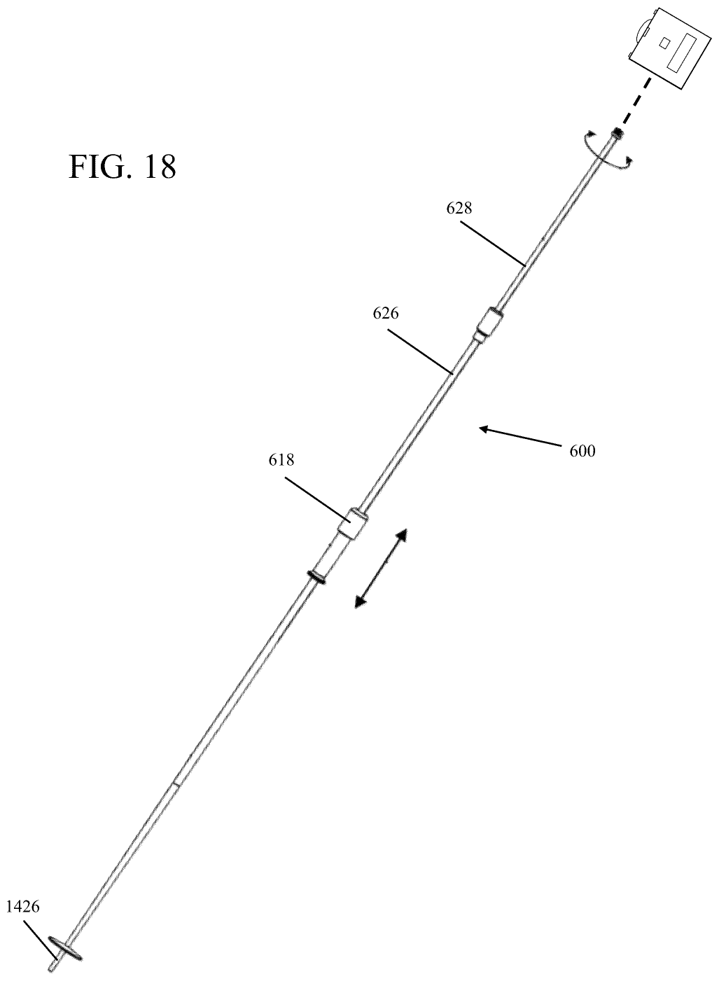

FIG. 17 is a front, perspective view of another embodiment of the accessory 1400, which is configured as the ski pole 600 seen in FIG. 6A (or other such sporting implement or apparatus).

The optical module 1300 is configured for connection to the grip 618, which includes: the power source 1402; the SoC 1406; the heat sink 1408; the display 1410; and the buttons 1414, as discussed above in connection with the embodiment of the accessory 1400 seen in FIG. 12. In the illustrated embodiment, the grip 618 and the optical module 1300 are configured such that the optical module 1300 is rotatable in relation to the grip 618. Embodiments in which the grip 618 and the optical module 1300 may be non-rotatably connected are also envisioned herein, however, and would not be beyond the scope of the present disclosure.

Although the ski pole 600 is shown as including the optical module 1300, alternatively, it is envisioned that that ski pole 600 may include the (omni-directional, spherical) optical module 1600 (FIG. 14).

In the illustrated embodiment, the ski pole 600 includes a fixed length. It is also envisioned, however, that the ski pole 600 may include a variable length. More specifically, as discussed above in connection with FIG. 6B, it is envisioned that the ski pole 600 may include the aforementioned (telescoping) segments 626, 628, which are extendable in relation to the grip 618 (i.e., away from a tip 1426 of the ski pole 600) in order to vary the overall length of the ski pole 600 and the position of the optical module 1300.

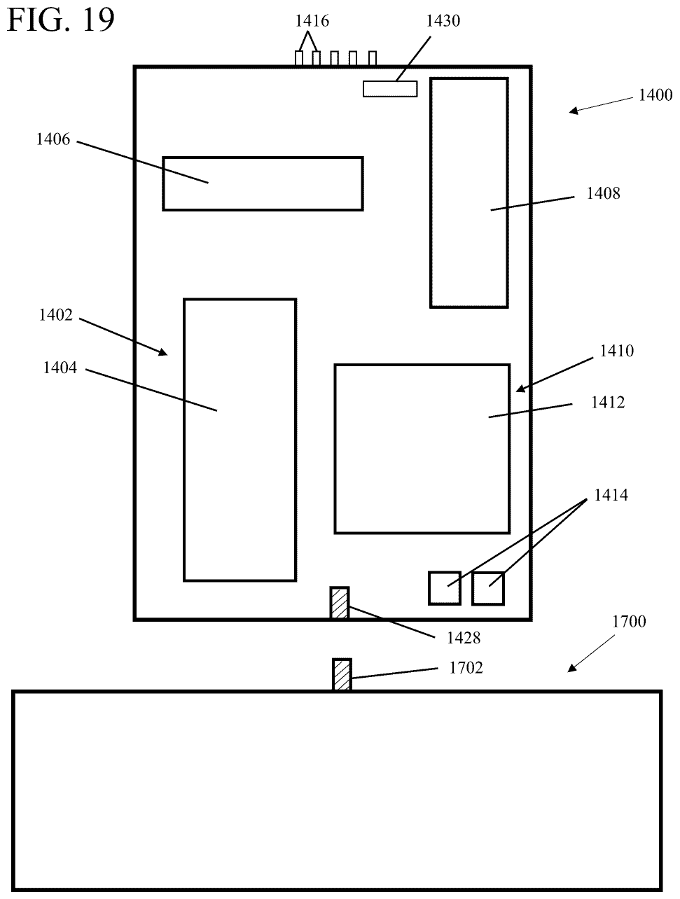

FIG. 19 is a schematic view of another embodiment of the accessory 1400, which includes a connector 1428 that is configured for connection to a (second) accessory 1700 such as, for example, an additional (e.g., larger) tripod, base, etc., via a corresponding connector 1702.

In the illustrated embodiment, the connectors 1428, 1702 are configured for threaded engagement. It should be appreciated, however, that the accessories 1400, 1700 may be configured for (releasable) connection in any suitable manner. For example, embodiments of the accessories 1400, 1700 including corresponding finger assemblies, ball-and-socket assemblies, magnets, clips, etc., are also envisioned herein and would not be beyond the scope of the present disclosure.

The SoC 1406 includes various electrical components that support operation of the image capture system 1200 including, for example, processing, power management, memory, wireless communication, etc. The SoC 1406 is physically separated from, but is electrically connected to, the optical module 1300 (i.e., the ISLA 1302) via a tether 1800, which may include any cable, connector, or other such transmission member suitable for the intended purpose of facilitating the communication of data and/or power between the optical module 1300 (i.e., the ISLA 1302) and the accessory 1400 (i.e., the SoC 1406).

As seen in FIG. 12, in certain embodiments, it is envisioned that the optical module 1300 and the accessory 1400 may include corresponding serialization and deserialization (SerDes) circuits 1316, 1430, respectively. A SerDes implementation includes parallel-to-serial (serial-to-parallel) data conversion, impedance matching circuitry, and clock data recovery functionality. More specifically, the serialization circuit 1316 converts parallel signals from the image sensor 1312 into a serial signal prior to transmission through the tether 1800, and the serialization circuit 1430 converts the serial signal to parallel signals for communication to the SoC 1406. Employing the respective serialization and deserialization circuits 1316, 1430 may allow for a reduction in the number of interconnects, for the use of smaller connectors, for a reduction in the overall gauge of the tether 1800, and/or an increase in the length of the tether 1800, thereby simplifying construction of the image capture system 1200 and reducing cost.

In certain embodiments, it is envisioned that the optical module 1300 and/or the accessory 1400 may be configured for use in humid and/or wet (e.g., underwater) environments. In such embodiments, it is envisioned that the optical module 1300 and the accessory 1400 may include one or more seals, gaskets, etc., in order to inhibit (if not entirely prevent) the intrusion of water.

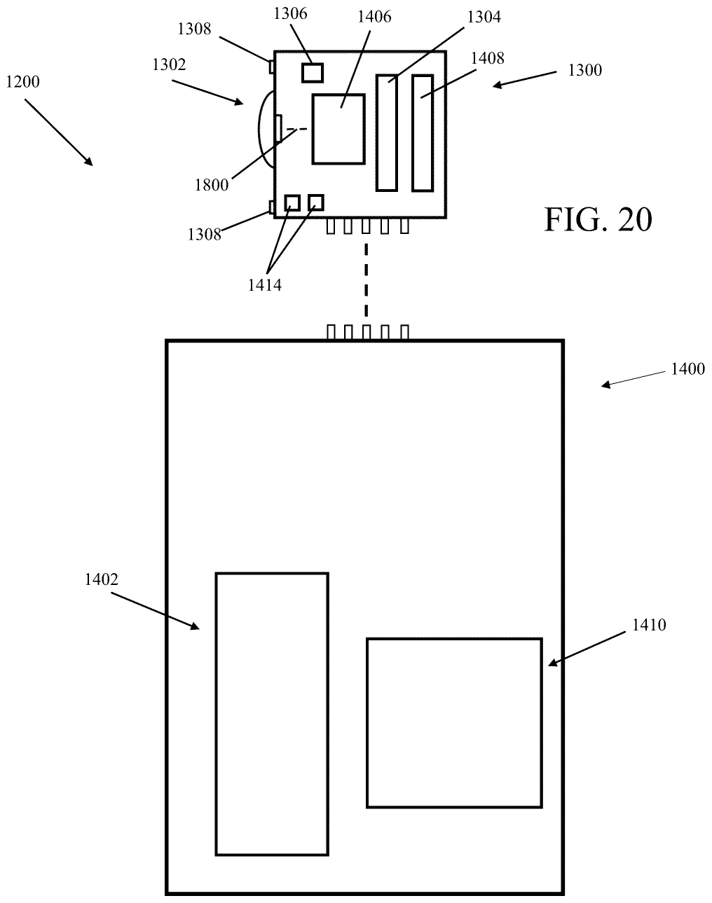

FIG. 20 is a schematic view of another embodiment of the image capture system 1200, which includes an alternate distribution of components. More specifically, in the embodiment of the image capture system 1200 illustrated in FIG. 20, the optical module 1300 includes: the ISLA 1302, the heat sinks 1304, 1408, the IMU 1306, the microphone(s) 1308, the SoC 1406, and the operational button(s) 1414, whereas the accessory 1400 includes the power source 1402 and the display 1410. Including the ISLA 1302, the heat sinks 1304, 1408, the IMU 1306, the microphone(s) 1308, the SoC 1406, and the operational button(s) 1414 in the optical module 1300 allows for a reduction in (if not the elimination of) data transmission through the tether 1800.

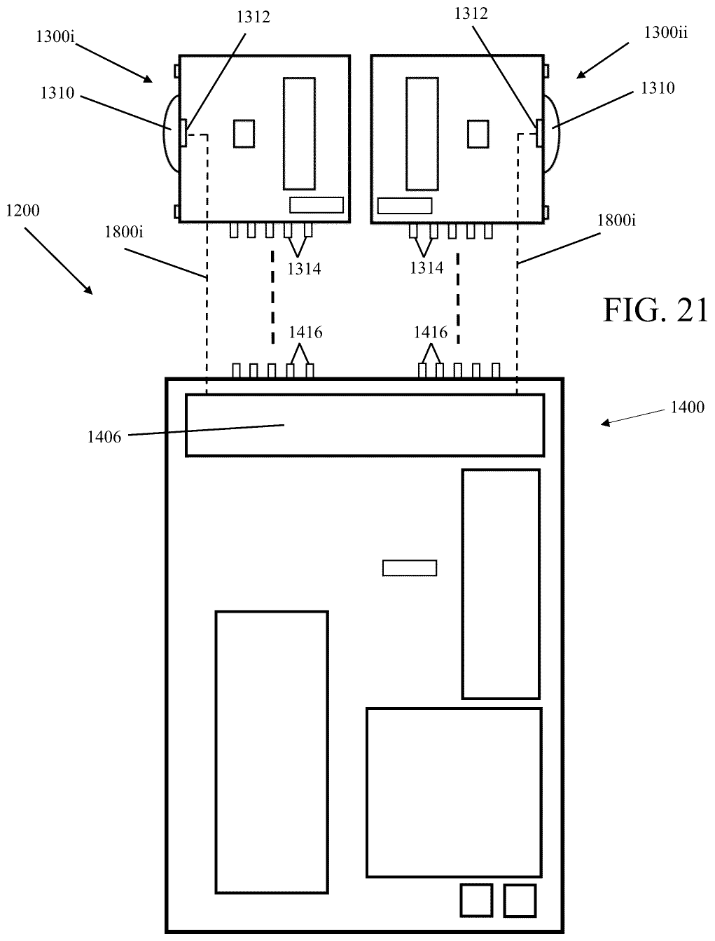

FIG. 21 is a schematic view of another embodiment of the image capture system 1200, which includes a pair of (first and second) optical modules 1300i, 1300ii that are configured for connection to the accessory 1400 (e.g., via the respective connector pins 1314, 1416), as discussed above. The sensors 1312 in each optical module 1300i, 1300ii are in communication with the SoC 1406 (e.g., via separate tethers 1800i, 1800ii), which stitches together the images captured by the optical modules 1300i, 1300ii to form a cohesive, combined image.

In the illustrated embodiment, the optical modules 1300i, 1300ii are shown as being oriented in generally opposite directions, which allows for the generation of a spherical image. Embodiments are also envisioned, however, in which the optical modules 1300i, 1300ii may be oriented in generally common (identical) directions, which would allow for the use of smaller lenses 1310 while achieving a wider field-of-view in comparison to embodiments of the image capture system 1200 that include a single optical module 1300 (e.g., as illustrated in FIG. 12). For example, it is envisioned that each optical module 1300i, 1300ii may be configured to define a field-of-view that lies substantially within the range of approximately 45 degrees to approximately 135 degrees (for a combined field-of-view that lies substantially within the range of approximately 90 degrees to approximately 270 degrees upon stitching together of the images captured by the optical modules 1300i, 1300ii). Additionally, embodiments are envisioned in which the optical modules 1300i, 1300ii may be angularly offset from each so as to define intersecting (i.e., non-parallel) optical axes.

Although the optical modules 1300i, 1300ii are shown as being generally identical in configuration in FIG. 21, embodiments in which the optical modules 1300i, 1300ii may include dissimilar (i.e., non-identical) configurations would not be beyond the scope of the present disclosure. For example, it is envisioned that the optical modules 1300i, 1300ii may define different (e.g., narrow and wide) fields-of-view, which would allow for increased resolution in the area of overlap between the images captured by the optical modules 1300i, 1300ii. Additionally, or alternatively, it is envisioned that the optical modules 1300i, 1300ii be configured for operation according to different modalities. For example, in one embodiment, it is envisioned that one of the optical modules 1300i, 1300ii may be configured to capture an infrared image (e.g., to facilitate ranging), and in another embodiment, it is envisioned that the optical modules 1300i, 1300ii may be configured to capture images with different resolutions.

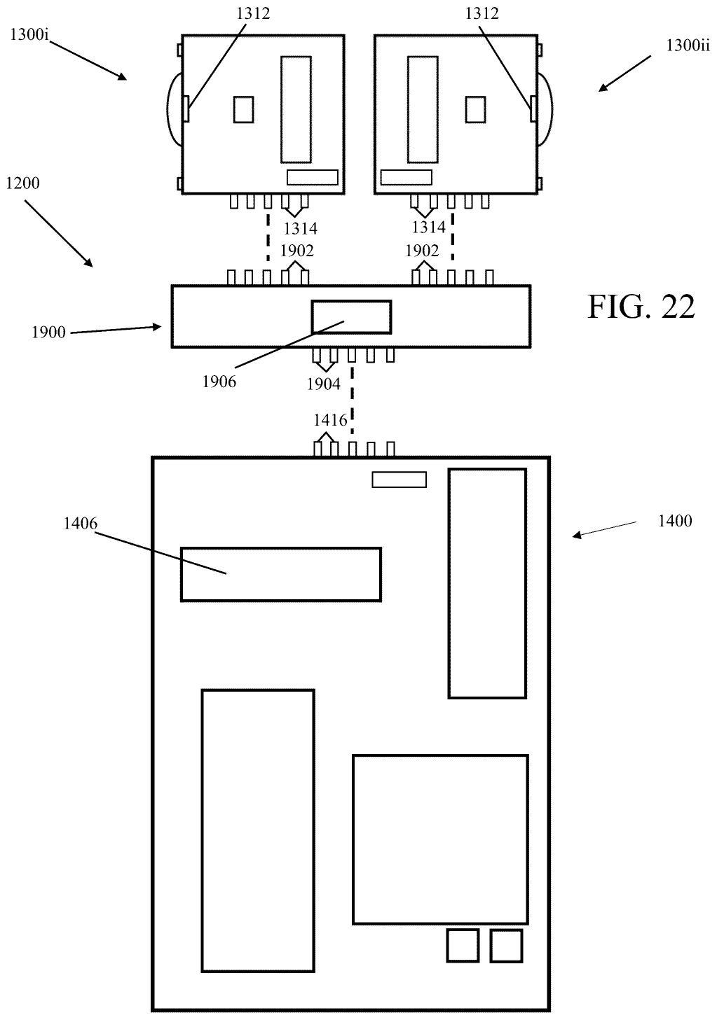

FIG. 22 is a schematic view of another embodiment of the image capture system 1200, which includes the optical modules 1300i, 1300ii and an interposer 1900, which is configured to (indirectly) connect the optical modules 1300i, 1300ii to the accessory 1400. More specifically, the interposer 1900 includes (first) connector pins 1902, which are configured to interface with the connector pins 1314 on the optical modules 1300i, 1300ii, and (second) connector pins 1904, which are configured to interface with the connector pins 1416 on the accessory 1400.

In the illustrated embodiment, the interposer 1900 is configured to combine the digital signals from the image sensors 1312 (e.g., via a logic circuit 1906 or the like) into a single signal that is then communicated to the accessory 1400. Embodiments are also envisioned, however, in which the digital signals from the image sensors 1312 may be transmitted to the accessory 1400 through the interposer 1900 and subsequently combined into a single signal in the accessory (e.g., via the SoC 1406).

While the present disclosure has been described in connection with certain embodiments, it is to be understood that the present disclosure is not to be limited to the disclosed embodiments, but, on the contrary, is intended to cover various modifications and equivalent arrangements included within the scope of the appended claims, which scope is to be accorded the broadest interpretation to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “generally,” “approximately,” “substantially,” and the like should be understood to include the numerical range, concept, or base term with which they are associated as well as variations in the numerical range, concept, or base term on the order of up to 25% (e.g., to allow for manufacturing tolerances and/or deviations in design). For example, the term “generally parallel” should be understood as referring to an arrangement in which the pertinent components (structures, elements) subtend an angle therebetween that is equal to 180° as well as an arrangement in which the pertinent components (structures, elements) subtend an angle therebetween that is greater than or less than 180° (e.g., +10%, +15%, +25%). The term “generally parallel” should thus be understood as encompassing configurations in which the pertinent components are arranged in parallel relation. Similarly, the term “generally identical” should be understood as encompassing configurations in which the pertinent components are identical in configuration as well as configurations in which there may be insubstantial variations between the pertinent components that do not influence the substantive construction or performance thereof.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure, etc.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A ski pole assembly, comprising:
a ski pole that defines a cavity;
an extension at least partially received by the cavity, wherein the extension is configured to traverse the cavity along a longitudinal axis of the ski pole; and
a mounting mechanism coupled to the extension and configured to removably couple an attachment to the extension.

2. The ski pole assembly of claim 1, further comprising:
a grip that surrounds a portion of the ski pole and that defines a cavity, wherein the extension is configured to be at least partially located within the cavity of the grip.

3. The ski pole assembly of claim 1, wherein the extension is configured to move with respect to the ski pole along the longitudinal axis of the ski pole such that the extension moves into and out of the ski pole.

4. The ski pole assembly of claim 1, wherein the ski pole assembly further includes a grip that defines a cavity therein that is coaxial with the cavity of the ski pole and extends along the longitudinal axis of the ski pole.

5. The ski pole assembly of claim 4, wherein the extension is configured to be received by the cavity of the grip and the cavity of the ski pole.

6. The ski pole assembly of claim 1, wherein the extension includes:
a first segment pivotally coupled to a grip that surrounds the cavity of the ski pole and configured to move with respect to the grip along the longitudinal axis of the ski pole, wherein the first segment defines a cavity therein; and
a second segment pivotally coupled to the first segment and configured to be at least partially received by the cavity of the first segment.

7. The ski pole assembly of claim 6, wherein the second segment is configured to move with respect to the first segment along a longitudinal axis of the first segment.

8. The ski pole assembly of claim 1, further comprising:
a support arm pivotally coupled to the extension and configured to be at least partially received by the cavity of the ski pole, wherein the support arm is configured to couple to the ski pole.

9. The ski pole assembly of claim 8, wherein the extension includes:
a first end, wherein the mounting mechanism is coupled to the first end; and
a second end that opposes the first end, wherein the support arm is pivotally coupled to the extension between the first end and the second end.

10. The ski pole assembly of claim 1, wherein the mounting mechanism includes:
a pair of fingers that are configured to interlock with another pair of fingers associated with the attachment, wherein the attachment is configured to pivot with respect to the mounting mechanism.

11. The ski pole assembly of claim 10, wherein the mounting mechanism is rotatably coupled to the extension.

12. The ski pole assembly of claim 1, wherein the mounting mechanism includes:
a ball portion that is configured to be removably coupled to the attachment; and
a socket portion that is coupled to the extension and receives the ball portion therein.

13. The ski pole assembly of claim 1, wherein the extension includes an indicator line that indicates a position of the extension with respect to the ski pole such that the attachment counterbalances the ski pole.

14. The ski pole assembly of claim 1, wherein the attachment is a camera.

15. A ski pole assembly, comprising:
a ski pole;
an extension connected to the ski pole; and
a mounting mechanism connected to the extension and configured for removable connection to an image capture apparatus such that the image capture apparatus is connectable to the ski pole via the extension.

16. The ski pole assembly of claim 15, wherein the extension is rotatably connected to the ski pole to facilitate repositioning of the image capture apparatus.

17. The ski pole assembly of claim 15, wherein the extension is telescopically reconfigurable between collapsed and expanded configurations.

18. A ski pole assembly, comprising:
a mounting mechanism configured for engagement with an image capture apparatus such that the image capture apparatus is directly connectable to the ski pole assembly.

19. The ski pole assembly of claim 18, wherein the mounting mechanism includes first fingers configured for engagement with second fingers on the image capture apparatus.

20. The ski pole assembly of claim 18, wherein the mounting mechanism includes a threaded fastener configured for engagement with the image capture apparatus.
